(19) United States
(12) Patent Application Publication
(10) Pub. No.: US 2026/0330366 A1
(43) Pub. Date: Oct. 22, 2026

(54) SYSTEM

(71) Applicant: SoftBank Group Corp., Tokyo (JP)

(72) Inventor: Yusuke HIURA, Tokyo (JP)

(73) Assignee: SoftBank Group Corp., Tokyo (JP)

(21) Appl. No.: 19/648,401

(22) Filed: Apr. 15, 2026

(30) Foreign Application Priority Data
Apr. 22, 2025 (JP) 2025-070244

(51) Int. Cl. G06Q 10/0631; G06N 3/045; G06N 3/0475; G06Q 10/047; G06Q 10/0639

(52) U.S. Cl. CPC G06Q 10/06316; G06N 3/045; G06N 3/0475; G06Q 10/047; G06Q 10/0639

(57) ABSTRACT

The present invention relates to a corporate sales support system that integrally realizes customer information management, sales activity support, and customer relationship strengthening in corporate sales activities, and realizes business efficiency improvement for both a sales representative and a customer, sophistication of decision-making, customer satisfaction improvement, strengthening of competitiveness, and long-term relationship building by centrally managing various data such as customer attribute information, transaction history, feedback, contract information, project progress, external lead information, competitor information, and market trends on a server, and automating and optimizing customer needs extraction, prospective customer identification, automatic sales task generation, sales forecasting, competitive analysis, proposal material creation, feedback analysis, project and contract management, training provision, communication optimization, and the like using a generative AI.

### CROSS-REFERENCE TO RELATED APPLICATION

The present application claims priority to and incorporates by reference the entire contents of Japanese Patent Application No. 2025-070244 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is to comprehensively solve fundamental problems in conventional corporate sales activities, such as information fragmentation, personalized responses, inefficient business processes, and difficulty in building relationships with customers, by realizing business efficiency improvement for both sales representatives and customers, sophistication of decision-making, customer satisfaction improvement, strengthening of competitiveness, and long-term relationship building, by integrally and in real-time providing functions such as centralized information management, data analysis, sales activity automation, feedback collection and analysis, project management, communication optimization, and provision of training and market insights utilizing a generative AI, for bidirectional problems including various business inefficiencies and limits of information utilization faced by sales representatives in corporate sales activities, such as complexity of customer information management, difficulty in discovering new prospective customers, inefficiency of sales activities, lack of accuracy in sales forecasting, difficulty in competitive analysis, time and effort for creating proposal materials, and lack of utilization of customer feedback, as well as problems faced by the customer side, such as difficulty in clarifying needs, time and effort for providing and analyzing feedback, lack of data sharing, inefficiency of project management, difficulty in grasping market trends, and necessity of smoothing communication.

### SUMMARY OF THE INVENTION

A means for solving the problems according to the present invention is to configure a corporate sales support system comprising a customer information management unit, a sales activity support unit, and a customer relationship strengthening unit, wherein the customer information management unit centrally accumulates and manages customer attribute information, transaction history, interests, contract information, feedback information, project progress information, shared data, training history, market insight information, and the like acquired from a corporate sales representative and a customer, and estimates a potential need and a future sales potential for each customer by analyzing these pieces of information using a generative AI; the sales activity support unit performs identification of a prospective customer, automatic task generation for sales activities, sales forecasting, competitive analysis, automatic generation of proposal materials, optimization of a sales strategy, and provision of training contents using a generative AI based on the information analyzed by the customer information management unit and lead information, competitor information, and market trend information acquired from an outside; and the customer relationship strengthening unit performs feedback collection and analysis from the customer, needs clarification support, data sharing, joint project management, contract management support, problem solving support, communication optimization, and proposal of customer satisfaction improvement measures using a generative AI by utilizing the information of the customer information management unit and the sales activity support unit, thereby realizing centralized information management, automation of business processes, sophistication of decision-making by data utilization, customer satisfaction improvement, strengthening of competitiveness, and long-term relationship building for both the corporate sales representative and the customer.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

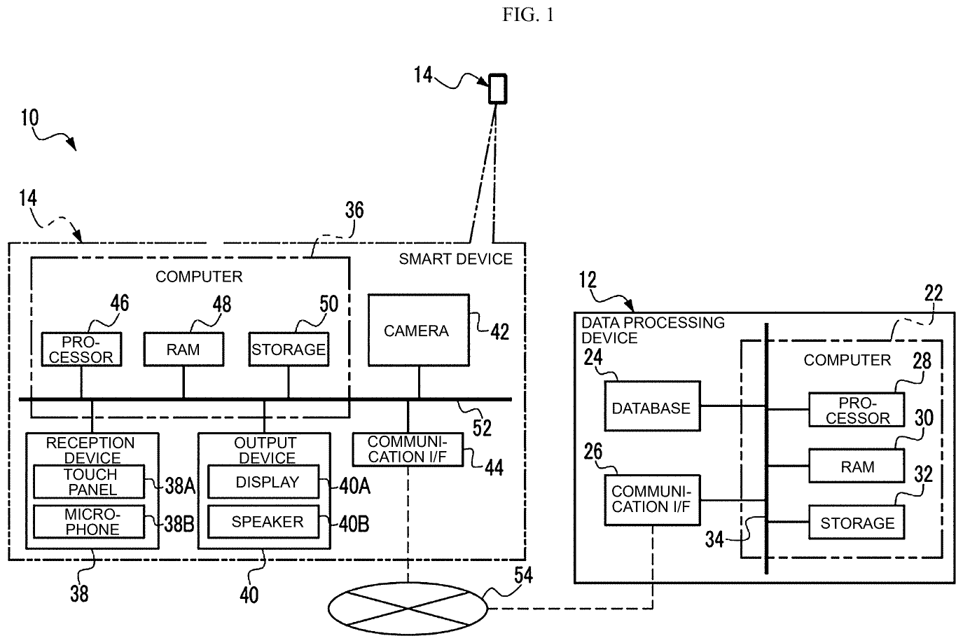

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

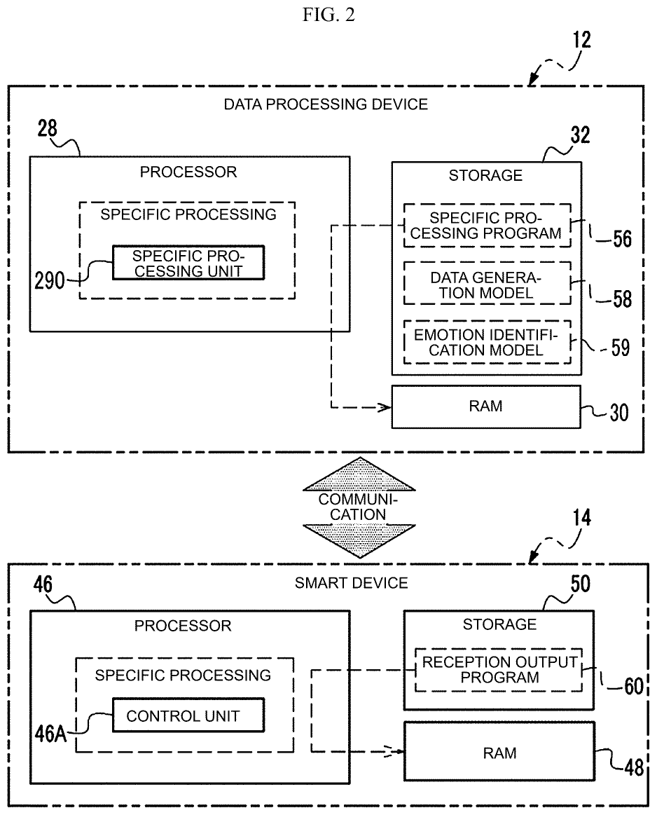

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### (Example 1)

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

An embodiment of the present invention is a corporate sales support system composed of a server and a terminal, wherein each unit of a customer information management unit, a sales activity support unit, and a customer relationship strengthening unit is mainly realized on the server, and the terminal functions as an interface for a sales representative and a customer to access. Hereinafter, the configuration of each unit, a specific utilization method of a generative AI, role sharing between the server and the terminal, and further specific operation examples will be comprehensively and in detail described. Specifically, the present system adopts a distributed computing architecture. The present server includes a parallel processing cluster composed of a plurality of computing nodes. The present terminal is connected to the present server via a secure communication protocol. The present system implements a plurality of neural networks including a large language model. The present neural network is based on a transformer architecture having a self-attention mechanism. The present system converts an input natural language text into a multidimensional word embedding vector. The present system computes the vector in a high-dimensional space. The present system thereby executes unconventional information processing different from human mental activity. The present system models tacit knowledge of the sales representative as quantitative tensor data. The present system thereby converts a personalized sales process into objective and reproducible computer processing. The present system reduces a response delay to a millisecond unit by parallelizing data processing. The present system thereby realizes real-time sales support. The present system is applied to a customer management use case in a BtoB business such as a manufacturing industry and an IT service industry.

First, the customer information management unit is realized on the server, and centrally accumulates and manages customer attribute information (for example, company name, person in charge name, department, job title, contact information, industry, number of employees, capital, location, sales scale, financial information, transaction start date, transaction history, purchase history, interests, contract information, contract start date/end date, contract amount, contract condition, feedback information, questionnaire result, project progress information, shared data, training history, market insight information, past complaint history, inquiry history, customer satisfaction score, sales representative history, visit history, mail and chat exchange history, and the like) input from the terminal by the sales representative and the customer in a database. For example, when the sales representative inputs new customer information from the terminal, the customer information management unit on the server receives this and stores it in the database. When the customer inputs their own needs and feedback from the terminal, they are similarly managed on the server. Furthermore, when the sales representative inputs a business negotiation content and a customer reaction from the terminal after a business negotiation, this is also managed on the server. The generative AI plays a role of analyzing these large amounts of and diverse data, and estimates a potential need and a future sales potential for each customer from the past transaction history and the feedback content, for example. Specifically, the generative AI analyzes free-description feedback of the customer using a natural language processing technology, extracts keywords and emotions such as “desire to shorten delivery time”, “interested in new product”, and “dissatisfied with support system”, and automatically classifies and tags an interest field and an issue for each customer. In addition, the generative AI also performs time-series analysis and clustering on numerical data such as sales data and transaction frequency, and automatically extracts “a customer with a high possibility of additional order within the next half year”, “a customer with a high cancellation risk”, “a customer with a high possibility of upselling”, and the like. For example, based on a purchase cycle of the customer and a transition of a past order amount, the generative AI can automatically calculate a “next order prediction date” and an “assumed order amount”, and notify the sales representative. Specifically, the present customer information management unit includes a distributed relational database and a NoSQL database storing unstructured data. The present system normalizes the input customer attribute information. The present system tokenizes text data and converts it into a 512-dimensional numerical vector. The present system inputs the numerical vector to the large language model. The present large language model includes a pre-trained transformer encoder. The present system receives, as input data, for example, a text tensor “desire to shorten delivery time” and time-series array data indicating a purchase amount for the past 12 months. The present system combines these pieces of input data to generate a multimodal feature amount tensor. The present system inputs the feature amount tensor to a multilayer perceptron. The present system outputs, as an output, a probability score from 0 to 1 indicating a degree of interest of the customer and timestamp data indicating the next order prediction date. The present system outputs structured data such as “degree of interest in new product 0.85” and “next order prediction date Oct. 1, 2023”, for example. The present system compares the output probability score with a predetermined threshold value. The present system activates a subsequent alert generation module when the score exceeds the threshold value. The present system thereby realizes highly accurate customer classification that does not rely on human intuition. The present system optimizes a weight of a model by a gradient descent method using a cross-entropy error function. The present system thereby continuously improves prediction accuracy. The present system is applied to a customer churn prediction use case in a corporate sales department of a financial institution, and the like.

The sales activity support unit is also realized on the server, and the generative AI performs optimization of sales activities based on the data accumulated and analyzed by the customer information management unit and the lead information (for example, business card data acquired at an exhibition, inquiry information via a website, reaction data on SNS, lead data via an advertisement, corporate information from an external database, industry news, public financial information, and the like), the competitor information (for example, product information of a competitor, price information, news article, SNS post, past lost order reason, sales strategy analysis of a competitor, and the like), and the market trend information (for example, industry report, economic indicator, trend analysis, legal regulation change information, and the like) acquired from the outside. For example, the business card data acquired at the exhibition is automatically read by OCR, and the generative AI automatically determines a priority of the prospective customer based on a past contract pattern and similarity with a customer attribute. Furthermore, when the sales representative inputs a progress of sales activities and a business negotiation content from the terminal, the generative AI analyzes this, automatically generates a specific sales task and proposal content such as “next approach is optimal in 3 days”, “proposal of service B is more effective than product A for this customer”, and “new proposal based on a trend of a competitor is necessary”, and presents them to the sales representative as a ToDo list or a notification on the terminal. For example, if there is a description such as “price negotiation is difficult” or “waiting for approval of a decision maker” in a business negotiation record, the generative AI proposes an action such as “presentation of a price adjustment plan” or “creation of additional material for a decision maker”. Regarding the sales forecasting, the generative AI comprehensively analyzes past business negotiation data, a current project progress, a purchase tendency of the customer, an industry trend, a seasonal factor, and the like, and automatically calculates a numerical value and a tendency such as “sales prospect for this month is 12 million yen”, “target achievement probability for next term is 85%”, and “sales of a specific customer group are in a decreasing trend”. Regarding the competitive analysis as well, the generative AI analyzes the information of the competitor acquired from the outside, and provides the sales representative with a strategic suggestion such as “since competitor X announced a new product, our proposal content should be changed”, “strength of competitor Y is price, but we can differentiate by support system”, and “since competitor Z started a price reduction campaign, we also consider a temporary discount”. In the automatic generation of proposal materials, the generative AI automatically creates a “proposal template for customer A”, a “customized proposal material for customer B”, a “competitor comparison table”, an “ROI simulation”, and the like based on an attribute for each customer, a past proposal content, a competitive situation, an interest field of the customer, an industry trend, and the like, and enables editing and outputting on the terminal. For example, when the sales representative presses a “create proposal” button on the terminal, the generative AI automatically generates a draft, and the sales representative can add and correct it as necessary. Regarding the provision of training contents as well, the generative AI automatically selects an optimal teaching material, video, FAQ, case study, role-play scenario, and the like according to a skill and an interest field of the sales representative and the customer, a past attendance history, a sales performance, and a feedback content, and makes them viewable on the terminal. For example, a basic sales skill teaching material is automatically distributed to a new sales representative, and a teaching material of an advanced negotiation technique and an industry trend analysis is automatically distributed to a veteran sales representative. Specifically, the present sales activity support unit includes a stream processing engine that processes the lead information and the market trend information acquired via an external API in real time. The present system inputs pixel data of the acquired business card image to a convolutional neural network. The present system extracts a feature map of a character region from the image tensor. The present system inputs the extracted feature map to a recurrent neural network, and decodes text data. The present system combines the decoded text data and past contract data, and calculates a customer similarity as a cosine similarity. The present system generates a sales task using a large language model. The present system receives, as an input, a text vector of a business negotiation record and an embedding vector of a news article of a competitor. The present system outputs, as an output, a label of a recommended sales action and its reliability score. The present system outputs data such as “presentation of price adjustment plan (reliability 0.92)” and “creation of additional material (reliability 0.88)”, for example. The present system writes the output action label in a task management database of the terminal. The present system uses a long short-term memory network for the sales forecasting. The present system takes a time-series array of a past sales result as an input, and outputs a future sales forecast value as a continuous value. The present system performs learning using a mean square error as a loss function. The present system thereby realizes highly accurate sales forecasting capturing a seasonal variation and a minute change in a market. The present system uses a conditional generative adversarial network or an autoregressive language model in the automatic generation of proposal materials. The present system thereby significantly reduces a material creation time of the sales representative, and promotes efficient utilization of computer resources. The present system is applied to a proposal activity use case in software sales.

The customer relationship strengthening unit is also realized on the server, and the generative AI supports relationship building with the customer and customer satisfaction improvement while utilizing the information of the customer information management unit and the sales activity support unit. For example, when feedback is input from the customer through the terminal, the generative AI analyzes its content, automatically classifies it into “positive opinion”, “improvement request”, “complaint”, “new function request”, “dissatisfaction with price”, “evaluation of support system”, and the like, and proposes a specific action such as “prompt apology response is necessary”, “feedback transfer to development department of new function”, “consideration of price review”, and “proposal of strengthening support system” to the sales representative. For example, when the customer inputs “delivery time was delayed”, the generative AI proposes “cause analysis of delivery delay”, “presentation of alternative plan”, “automatic generation of apology mail”, and the like. As the needs clarification support, the generative AI automatically extracts “there is a high possibility that your company's issues are cost reduction and delivery time shortening”, “interested in new business development”, “considering renewal of IT infrastructure”, and the like based on a past remark and input content of the customer, a purchase history, an inquiry content, a questionnaire result, an industry trend, and the like, and presents them to the sales representative and the customer themselves. Regarding the data sharing, the generative AI determines an access right and a timing for a material, a progress report, a contract document, an estimate document, a delivery document, a billing document, a project plan document, minutes, an FAQ, a training teaching material, and the like managed on the server, and distributes them to the terminal in a form such as “automatic sending of project progress report on a weekly basis”, “automatic reminder at contract renewal timing”, and “automatic distribution of related material at time of new product release”. In the joint project management, the generative AI analyzes a progress of a task, a load situation of a person in charge, a delivery date, resource allocation, a risk factor, a request change from the customer, and the like, and automatically notifies “reminder to person in charge B because task A is delayed”, “progress rate of entire project is 80%”, “proposal of early response because risk factor occurred”, “influence analysis for specification change request from customer”, and the like. As the contract management support, the generative AI analyzes a contract content, a renewal timing, a past negotiation history, a contract condition change history, a payment situation, a contract violation risk, and the like, and realizes “automatic notification 30 days before contract expiration”, “proposal of timing of price revision negotiation”, “risk evaluation at time of contract condition change”, “automatic detection of non-payment risk”, and the like. In the problem solving support, the generative AI searches and summarizes a past case, a knowledge base, an FAQ, an internal manual, external public information, expert knowledge, and the like for an issue and a question sent from the customer and the sales representative through the terminal, and immediately answers in a form such as “presentation of solution of similar project”, “extraction of corresponding item from FAQ”, “escalation proposal to expert”, and “step-by-step guide to solution”. As the communication optimization, the generative AI analyzes a communication history and a reaction tendency for each customer, a past response history, a personality tendency of the customer, an industry characteristic, a cultural background, and the like, and proposes a personalized communication means and timing such as “customer C has better reaction by chat than mail”, “customer D prefers contact at beginning of week”, “regular telephone follow-up is effective for customer E”, and “early information provision is necessary for customer F because decision making takes time”. Regarding the proposal of customer satisfaction improvement measures as well, the generative AI comprehensively analyzes an evaluation and feedback of the customer, a transaction history, a competitive situation, an industry trend, a growth stage of the customer, and the like, and presents a specific measure such as “regular follow-up is effective”, “preferential implementation of guidance of new service”, “customized proposal for each customer”, “introduction of loyalty program”, and “invitation to customer event” to the sales representative. Specifically, the present customer relationship strengthening unit executes emotion analysis of customer feedback using a natural language processing model. The present system inputs the input feedback text to an encoder based on a BERT architecture. The present system receives, as input data, a token embedding tensor of a character string “dissatisfied with support system”, for example. The present system outputs, as an output, a probability distribution belonging to each class of positive, negative, and neutral. The present system outputs numerical data such as “negative probability 0.95” and “complaint classification flag 1”, for example. The present system automatically triggers a complaint response module based on the output result. The present system inputs a past remark and a purchase history of the customer to a graph neural network. The present system calculates a weight of an edge between a customer node and a product node, and quantifies a potential need as a distance in a vector space. The present system thereby automatically extracts a hidden issue such as “cost reduction” and “IT infrastructure renewal”. The present system inputs progress data of a task and resource allocation data to a reinforcement learning agent in the joint project management. The present system outputs an optimal resource reallocation policy that minimizes a delay risk of a project based on a Markov decision process. The present system automatically generates a reminder notification to a person in charge according to the output policy. The present system analyzes a reaction history of the customer by a collaborative filtering algorithm for the communication optimization. The present system thereby determines an optimal contact means and time zone for each customer. The present system maximizes customer satisfaction as an objective index by these unconventional calculation methods. The present system is applied to a long-term relationship building use case in a consulting industry.

The terminal side provides a user interface for the sales representative and the customer to access each unit on the server, and is realized in a form of, for example, a web browser, a smartphone application, a tablet application, a dedicated business terminal, and the like. On the terminal, a sales task, a proposal material, a progress report, a feedback result, a training content, contract information, a communication proposal, a project management screen, a dashboard, an alert notification, an FAQ, a knowledge base, and the like transmitted from the server can be viewed, edited, and input. For example, an operation is possible in which the sales representative confirms customer information with a smartphone from a visiting destination and inputs feedback on the spot after a business negotiation, or the customer inputs their own request and a project progress from a tablet terminal, a sales manager grasps an overall sales progress and a risk project on a dashboard, the customer views an FAQ and a training video, and the sales representative receives an alert notification and immediately responds. Specifically, the present terminal includes a communication control unit that transmits and receives a data packet to and from the present server using an asynchronous communication protocol. The present terminal includes a drawing processing unit that parses the received data in a JSON format and dynamically renders it on a graphical user interface. The present terminal detects a touch operation and a keyboard input of a user by an event listener. The present terminal temporarily stores the detected input event as log data together with a timestamp in a local memory. The present terminal batch-transmits the log data to the present server at a predetermined timing. The present system minimizes an influence of a network delay by a data cache mechanism on the terminal side. The present system thereby improves a response speed to a user operation. The present terminal receives the alert notification transmitted from the present server as a push notification in a background process. The present terminal evaluates a priority score of the received notification. The present terminal immediately displays a pop-up dialog on a screen when the priority score exceeds a predetermined threshold value. The present system thereby prevents an omission of response to an important sales task. The present system executes a power saving algorithm that limits unnecessary background communication in order to efficiently manage a hardware resource of the terminal. The present system is applied to a field sales use case that supports sales activities in a mobile environment.

Furthermore, the utilization of the generative AI is not limited to mere data analysis and automatic generation, but is diverse, for example, automatically detecting an input mistake and an information omission of the sales representative and performing input assistance and a correction proposal, providing a chatbot function that automatically responds to an inquiry of the customer 24 hours a day, presenting personalized sales advice in real time based on a past behavior pattern and a performance of the sales representative, performing future demand prediction and risk prediction based on a purchase tendency of the customer and a market trend, automatically generating a performance analysis and an improvement proposal of an entire team for a sales manager, and automatically designing an optimal price strategy and a campaign proposal for each customer. For example, if there is an ambiguous expression or an omission in the business negotiation content input by the sales representative, the generative AI performs input assistance such as “please input a specific business negotiation amount” and “please describe a name of a decision maker”. For example, even when an inquiry from the customer arrives at midnight, the generative AI automatically makes a primary answer, and hands over a response content to the sales representative the next morning. For example, based on a tendency of a project that the sales representative lost an order in the past, the generative AI gives advice such as “an additional proposal should be made early for a project in which a similar lost order reason is likely to occur”. For example, based on a purchase history of the customer and an industry trend, demand prediction such as “since there is a possibility that demand for a specific product will increase next month, propose securing inventory in advance” is performed. For example, the sales manager confirms an activity situation of the entire team on the dashboard, and the generative AI automatically generates an improvement proposal such as “since the number of acquisitions of new projects is in a decreasing trend this month, strengthening of a lead acquisition measure is recommended”. For example, based on a past price negotiation history and a competitive situation for each customer, a price strategy such as “a 10% discount is effective for this customer” and “propose a special offer to counter a campaign of a competitor” is automatically designed. Specifically, the present system implements a character-level autoregressive model in order to realize an input assistance function. The present system acquires a text stream being input by the sales representative in real time. The present system converts the text stream into a context vector, and calculates a probability distribution of a word appearing next. The present system presents a sequence of words having the highest probability on the screen as a prediction candidate. The present system adopts a retrieval-augmented generation architecture in the chatbot function. The present system converts an inquiry text from the customer into a query vector. The present system searches for an internal document having a high similarity from a vector database. The present system combines a text of the searched document and the original inquiry text, and inputs them as a prompt of the large language model. The present system generates an answer text in a natural language as an output. The present system outputs a specific answer text “a dimension of product A is X, and a weight is Y” for “a question regarding a specification of product A”, for example. The present system uses a gradient boosting decision tree algorithm in the demand prediction. The present system takes a multidimensional feature amount vector such as a past purchase history, a seasonal dummy variable, and a macroeconomic indicator as an input. The present system outputs a predicted sales quantity for each product in the next month as a continuous value as an output. The present system automatically generates an ordering recommendation alert when the output predicted sales quantity falls below an inventory threshold value. The present system thereby reduces an inventory shortage risk, and contributes to efficiency improvement of a supply chain. The present system is applied to a wholesale sales use case for a retail industry.

As described above, in the embodiment of the present invention, the generative AI is responsible for accumulation, analysis, automatic generation, and proposal of various types of information on the server, and a configuration is adopted in which the sales representative and the customer can intuitively and in real time utilize and input information on the terminal side, whereby all processes of corporate sales activities are highly optimized, and centralized management of information, automation of business, sophistication of decision making by data utilization, customer satisfaction improvement, strengthening of competitiveness, and building of a sustainable business relationship can be realized. For example, when the sales representative discovers a new prospective customer, the generative AI automatically extracts an optimal target based on a past contract pattern and a market trend, and automatically generates even an approach method and a proposal content. For example, when the customer inputs their own issue and request, the generative AI analyzes its content, and immediately proposes an optimal solution and a related service. For example, the generative AI automatically manages a project progress and a contract renewal timing, and performs notification and a reminder to a person concerned at an appropriate timing. For example, when the sales representative and the customer need training and a market insight, the generative AI automatically selects and distributes an optimal content according to an individual need and a skill level. For example, based on a tendency of a project that the sales representative lost an order in the past, the generative AI gives advice such as “an additional proposal should be made early for a project in which a similar lost order reason is likely to occur”. For example, based on a purchase history of the customer and an industry trend, demand prediction such as “since there is a possibility that demand for a specific product will increase next month, propose securing inventory in advance” is performed. For example, the sales manager confirms an activity situation of the entire team on the dashboard, and the generative AI automatically generates an improvement proposal such as “since the number of acquisitions of new projects is in a decreasing trend this month, strengthening of a lead acquisition measure is recommended”. For example, based on a past price negotiation history and a competitive situation for each customer, a price strategy such as “a 10% discount is effective for this customer” and “propose a special offer to counter a campaign of a competitor” is automatically designed. Including these specific operation examples, by cooperative operation of the server and the terminal and advanced utilization of the generative AI, inefficiency, information fragmentation, and a personalized response in conventional corporate sales activities are fundamentally resolved, and sustainable corporate growth and customer satisfaction improvement are realized. Specifically, the present system includes an orchestration engine that integrally manages a plurality of artificial intelligence models. The present system integrates an inference result of each model by ensemble learning. The present system thereby offsets a prediction error of a single model, and improves inference accuracy of the entire system. The present system applies a data augmentation method to purchase history data of the customer. The present system artificially multiplies sample data of a lost order project using a synthetic minority over-sampling technique. The present system thereby improves generalization performance of a machine learning model in an imbalanced dataset. The present system applies a reinforcement learning algorithm in the automatic design of a price strategy. The present system defines a current customer state and a market environment as a state vector. The present system defines a discount rate to be presented as an action space. The present system sets a future expected revenue as a reward function. The present system calculates an optimal discount rate that maximizes a cumulative reward using a Q-learning algorithm. The present system receives numerical data of “past price elasticity of customer” and “current price of competitor” as an input. The present system outputs numerical data “recommended discount rate 10 percent” as an output. The present system passes the output result to an estimate document generation module, and automatically updates an estimate document. The present system thereby realizes a data-driven pricing process that does not depend on a human rule of thumb. The present system is applied to a renewal sales use case of a subscription-type service.

### (System Configuration)

The system according to the present embodiment includes a customer information management unit, a sales activity support unit, a customer relationship strengthening unit, a data analysis unit, a proposal material generation unit, a project management unit, a contract management unit, a training provision unit, a communication optimization unit, and an interface unit. Specifically, the present system containerizes and implements each of these units as a microservice architecture. The present system controls communication between the respective containers via a service mesh. The present system thereby improves scalability and fault tolerance of the system. The present system adopts a configuration in which each unit can independently scale out. The present system automatically additionally activates a container instance of the data analysis unit and the proposal material generation unit at a time of high load. The present system thereby realizes dynamic allocation of a computer resource, and optimizes utilization efficiency of a hardware resource. The present system utilizes a distributed message queuing system in order to share data among the respective units. The present system thereby enables asynchronous processing, and improves a processing throughput of the entire system. The present system is applied to a construction use case of a sales support platform for a large-scale enterprise.

The customer information management unit is a unit that centrally accumulates and manages customer attribute information input from a corporate sales representative and a customer, for example, company name, person in charge name, department, job title, contact information, industry, number of employees, capital, location, sales scale, financial information, transaction start date, transaction history, purchase history, interests, contract information, contract start date/end date, contract amount, contract condition, feedback information, questionnaire result, project progress information, shared data, training history, market insight information, past complaint history, inquiry history, customer satisfaction score, sales representative history, visit history, mail and chat exchange history, and the like in a database. For example, when the sales representative inputs new customer information from the terminal, this is received and stored in the database. For example, when the customer inputs their own needs and feedback from the terminal, they are similarly managed. For example, when the sales representative inputs a business negotiation content and a customer reaction from the terminal after a business negotiation, this is also a management target. For example, based on a purchase cycle of the customer and a transition of a past order amount, a next order prediction date and an assumed order amount can be automatically calculated and notified to the sales representative. Specifically, the present customer information management unit includes a data pipeline for integrating a wide variety of input data. The present system automates each processing step of extraction, transformation, and loading. The present system removes noise from the input text data, and complements a missing value by a statistical method. The present system applies a hidden Markov model in order to analyze the purchase cycle of the customer. The present system inputs a past purchase history as an observation sequence. The present system estimates a transition of a purchase motivation of the customer as a latent state. The present system calculates a probability distribution of transitioning to a next purchase state as an output. The present system outputs numerical data “purchase probability within 30 days 0.75”, for example. The present system calculates specific date data as the next order prediction date when the probability exceeds a predetermined threshold value. The present system automatically links the calculated date data to a calendar application of the sales representative. The present system thereby optimizes a timing of an approach of the sales representative, and prevents an opportunity loss. The present system reduces a response time of a search query for millions of customer records to a sub-millisecond unit by optimizing an index structure of the database. The present system is applied to a customer management use case of multi-product high-frequency transaction in a trading company.

The sales activity support unit is a unit configured to perform optimization of sales activities utilizing a generative AI based on the data accumulated and analyzed by the customer information management unit and lead information acquired from an outside, for example, business card data acquired at an exhibition, inquiry information via a website, reaction data on SNS, lead data via an advertisement, corporate information from an external database, industry news, public financial information, and the like, competitor information, for example, product information of a competitor, price information, a news article, an SNS post, a past lost order reason, a sales strategy analysis of a competitor, and the like, and market trend information, for example, an industry report, an economic indicator, a trend analysis, legal regulation change information, and the like. For example, it automatically reads the business card data acquired at the exhibition by OCR, and automatically determines a priority of a prospective customer based on a past contract pattern and similarity with customer attributes. For example, when a sales representative inputs a progress of a sales activity or a business negotiation content, the generative AI analyzes this, automatically generates an optimal timing of a next approach and a proposal content, and presents them to the sales representative as a ToDo list or a notification on a terminal. For example, if there is a description such as “price negotiation is difficult” or “waiting for approval of a decision maker” in a business negotiation record, the generative AI proposes an action such as presentation of a price adjustment proposal or creation of an additional material for the decision maker. For example, regarding sales forecasting, it comprehensively analyzes past business negotiation data, a current project progress, a purchasing tendency of a customer, an industry trend, a seasonal factor, and the like, and automatically calculates a sales forecast for this month, a target achievement probability for a next term, a sales tendency of a specific customer group, and the like. Specifically, the present sales activity support unit includes a crawler module configured to periodically collect information from an external data source using a web scraping technology. The present system inputs the collected unstructured text into a named entity recognition model. The present system extracts entities such as a company name, a product name, and a price, and constructs a knowledge graph. The present system uses a model combining a convolutional neural network and a connectionist temporal classification loss function in the OCR processing of the business card data. The present system thereby achieves high recognition accuracy even for a blurred character or a special font. The present system uses a transformer-based sequence transduction model in the generation of a sales task. The present system receives an embedding vector of a text “price negotiation is difficult” as an input. The present system outputs a probability score of an action class “presentation of a price adjustment proposal” as an output. The present system uses a hybrid model combining an autoregressive integrated moving average model and a neural network in the sales forecasting. The present system receives past sales time-series data and external factor data as an input tensor. The present system outputs a confidence interval of a future sales forecast value as an output. The present system outputs data such as “sales forecast for this month is 12 million yen, error is plus or minus 500,000 yen”, for example. The present system thereby realizes precise sales forecasting in consideration of uncertainty. The present system is applied to a use case handling an expensive product such as corporate real estate sales.

The customer relationship strengthening unit is a unit in which the generative AI supports relationship building with the customer and customer satisfaction improvement while utilizing the information of the customer information management unit and the sales activity support unit. For example, when feedback is input from the customer, the generative AI analyzes its content, automatically classifies it into a positive opinion, an improvement request, a complaint, a new function request, dissatisfaction with a price, an evaluation of a support system, and the like, and proposes a specific action such as a prompt apology response, feedback transfer to a development department for a new function, consideration of a price review, and a strengthening proposal of the support system to the sales representative. For example, when the customer inputs “delivery date was delayed”, the generative AI proposes a cause analysis of a delivery delay, presentation of an alternative plan, automatic generation of an apology email, and the like. For example, it automatically extracts an issue and an interest based on a past remark and input content of the customer, a purchase history, an inquiry content, a questionnaire result, an industry trend, and the like, and presents them to the sales representative and the customer himself/herself. For example, the generative AI determines an access right and a timing for a material, a progress report, a contract document, an estimate document, a delivery document, a billing document, a project plan document, minutes, an FAQ, a training material, and the like managed on the server, and distributes them to the terminal in a form of weekly automatic sending of a project progress report, an automatic reminder of a contract renewal timing, automatic distribution of a related material at a time of a new product release, and the like. Specifically, the present customer relationship strengthening unit maps a feedback text from the customer to a multidimensional vector space. The present system calculates a hyperplane for classifying the vector into a plurality of categories using a support vector machine. The present system receives a TF-IDF feature vector of a text “delivery date was delayed” as an input. The present system outputs a probability score belonging to a “complaint” category as an output. The present system adopts a category having the maximum score as a determination result. The present system activates a natural language generation model when the determination result is “complaint”. The present system inputs a response history to a past similar complaint as a prompt, and outputs a draft text of an apology email. The present system automatically inserts the output draft text into a mailer of the sales representative. The present system uses a latent Dirichlet allocation, which is a topic model, in the issue extraction of the customer. The present system takes a past remark text group of the customer as an input, and outputs a distribution probability of a latent topic. The present system thereby detects that an appearance probability of a keyword group related to “cost reduction” is high. The present system combines a rule-based inference engine and a machine learning model in the automatic distribution of the material. The present system determines a current project phase of the customer, generates a URL link of a necessary document at an appropriate timing, and transmits it. The present system is applied to a customer support use case in an IT system introduction project.

A data analysis unit is a unit configured to highly analyze a wide variety of data collected from the customer information management unit, the sales activity support unit, and the customer relationship strengthening unit using a generative AI. For example, it integrally analyzes a purchase history and a business negotiation history of a customer, a feedback content, industry trend data, competitor information, an activity history of a sales representative, and the like, and extracts a sales forecast and a cancellation risk for each customer, a possibility of up-selling/cross-selling, a fluctuation factor of a customer satisfaction score, and the like. For example, it grasps a behavior pattern of the customer and a change in needs in real time by combining time-series analysis, clustering, and natural language processing. For example, it extracts a success factor and an improvement point by associating a result of a sales activity with a behavior pattern of the sales representative. For example, it analyzes a trend of a competitor and a market trend, and provides an insight to be reflected in its own sales strategy and product development. Specifically, the present data analysis unit utilizes a Hadoop ecosystem or a Spark cluster for distributed processing of a large-scale data set. The present system executes a clustering algorithm such as a k-means method or DBSCAN in order to analyze the behavior pattern of the customer. The present system normalizes an RFM indicator such as a purchase frequency, an average purchase amount, and a latest purchase date of the customer, and inputs it as a multidimensional feature vector. The present system outputs an ID of a cluster to which each customer belongs as an output. The present system assigns a label such as “excellent customer cluster” or “churn crisis cluster”, for example. The present system uses a random forest algorithm in the prediction of the cancellation risk. The present system inputs a feature amount such as a decrease in a service use frequency of the customer and the number of complaint occurrences. The present system outputs a cancellation probability score from 0 to 1 as an output. The present system outputs numerical data such as “cancellation probability 0.85”, for example. The present system automatically triggers a retention measure when the score exceeds a threshold value. The present system applies a process mining technology in the behavior analysis of the sales representative. The present system takes an event log of the sales activity as an input, and outputs a standard process model of a successful business negotiation as a Petri net. The present system thereby visualizes a sales process that is a bottleneck, and improves business efficiency. The present system is applied to a customer success use case in a SaaS business.

A proposal material generation unit is a unit configured to automatically create a proposal document template, a customized proposal material, a competitor comparison table, an ROI simulation, an introduction case collection, an FAQ collection, a price simulation material, and the like using a generative AI based on an attribute for each customer, a past proposal content, a competitive situation, an interest field of the customer, an industry trend, and the like. For example, when the sales representative presses a “create proposal document” button on the terminal, the generative AI automatically generates a draft, and the sales representative can add/correct it as necessary. For example, it automatically inserts an optimal case and an introduction effect according to an industry and a scale of the customer, and a past purchase history. For example, it automatically generates a material emphasizing its own superiority based on a proposal content and price information of a competitor. For example, it automatically incorporates an FAQ and an explanation of a support system according to the interest field and the issue of the customer. Specifically, the present proposal material generation unit includes a multimodal generation model integrating a natural language generation technology and a document layout analysis technology. The present system receives structured data in a JSON format including attribute data of the customer, a past proposal text, and spec data of a product as an input. The present system embeds these pieces of data into a prompt template, and inputs it into a large language model. The present system outputs markup language data including a title of each slide of the proposal document, a body text, and metadata of an image to be inserted as an output. The present system outputs text data such as “Slide 1: Proposal for solving your company's issue” and “Slide 2: ROI simulation result”, and corresponding numerical data for drawing a graph, for example. The present system passes the output markup language data to a PDF generation engine, and renders a final proposal document file. The present system executes a Monte Carlo simulation in the generation of the ROI simulation. The present system takes a current cost structure of the customer and a price of a product scheduled to be introduced as input parameters, and calculates a probability distribution of return on investment based on a plurality of scenarios. The present system outputs a calculation result as a visual chart image, and automatically embeds it into the proposal material. The present system thereby reduces a human resource required for material creation, and equalizes a quality of a proposal. The present system is applied to a planning proposal use case in an advertising agency.

A project management unit is a unit configured to centrally manage a progress of a joint project with the customer, a task, a person in charge, a delivery date, resource allocation, a risk factor, a request change from the customer, and the like, and perform detection and a reminder of a progress delay, early discovery of a risk factor, prioritization of a task, optimization of resource allocation, automatic generation of a progress report to the customer, and the like using a generative AI. For example, when a task A is delayed, it transmits an automatic reminder to a person in charge B. For example, it visualizes a progress rate and a risk factor of the entire project on a dashboard. For example, when there is a specification change request from the customer, it automatically performs an impact analysis and notifies a related party. For example, it automatically generates a progress report according to a delivery date and a milestone, and distributes it to the customer and an internal related party. Specifically, the present project management unit manages a data structure of a Gantt chart and a Kanban board on a graph database. The present system models a dependency relationship between tasks as a directed acyclic graph. The present system calculates the shortest completion time of the project using a critical path method. The present system collects progress data of each task in real time, and inputs it into a graph neural network. The present system outputs a delay probability of the entire project and a bottleneck risk of a specific task as a score as an output. The present system outputs data such as “delay probability of the entire project due to delay of task A is 0.7”, for example. The present system executes a resource reallocation algorithm based on the score. The present system outputs an optimal task assignment plan that levels a load of the person in charge while complying with the delivery date using a solver of a constraint satisfaction problem. The present system analyzes a specification change request text from the customer with a natural language processing model. The present system specifies an influence range that a change content gives to an existing task graph, and automatically calculates an increment of an additional man-hour and cost. The present system outputs a calculation result as an impact analysis report, and notifies the terminal of the related party. The present system thereby reduces uncertainty of project management, and realizes dynamic resource optimization by a computer. The present system is applied to a project management use case in system development and a construction industry.

A contract management unit is a unit configured to manage a contract content, a renewal timing, a past negotiation history, a contract condition change history, a payment status, a contract violation risk, and the like, and perform an automatic notification before contract expiration, a timing proposal of a price revision negotiation, a risk evaluation at a time of a contract condition change, automatic detection of an unpaid risk, an optimal condition proposal at a time of a contract renewal, and the like using a generative AI. For example, it transmits an automatic notification to the sales representative and the customer 30 days before the contract expiration. For example, it automatically generates an optimal price revision proposal based on the past negotiation history. For example, it automatically extracts a risk factor at the time of the contract condition change, and calls attention to the related party. For example, when a payment delay occurs, it automatically detects the unpaid risk, and proposes an early response. Specifically, the present contract management unit includes a contract document analysis pipeline combining optical character recognition and natural language processing. The present system takes a scanned contract document image as an input, and extracts text data. The present system inputs the extracted text into a BERT-based named entity recognition model. The present system outputs a key-value pair such as a contracting party, a contract amount, a valid period, and presence or absence of an automatic renewal clause as an output. The present system outputs structured data such as “contract end date: Mar. 31, 2024” and “automatic renewal: present”, for example, and stores it in a database. The present system compares a current date and the contract end date, and executes an automatic notification batch processing when a difference becomes within 30 days. The present system gives a past negotiation history text and current market price data as an input to a reinforcement learning model in the proposal of the price revision negotiation. The present system outputs an optimal presentation price that maximizes a profit while minimizing a churn risk of the customer as an output. The present system uses an isolation forest, which is an anomaly detection algorithm, in the detection of the unpaid risk. The present system takes the number of past payment delay days and a financial indicator of the customer as an input feature amount. The present system calculates an anomaly degree score as an output, and generates an alert when the score exceeds a threshold value. The present system thereby strengthens compliance of contract management, and reduces a financial risk. The present system is applied to a contract management use case in a leasing industry and a temporary staffing industry.

A training provision unit is a unit in which a generative AI automatically selects an optimal material, video, FAQ, case study, role-play scenario, and the like according to a skill and an interest field of a sales representative and a customer, a past attendance history, a sales performance, and a feedback content, and makes them viewable on a terminal. For example, it automatically distributes a basic sales skill material to a new sales representative. For example, it automatically distributes a material of an advanced negotiation technique and an industry trend analysis to a veteran sales representative. For example, it automatically provides a product introduction manual and a utilization case video for the customer. For example, it automatically proposes an individual training plan for overcoming a weak point to a representative whose sales performance is sluggish. Specifically, the present training provision unit includes a hybrid recommendation system combining content-based filtering and collaborative filtering. The present system receives profile data of the sales representative, a past attendance history vector, and a current sales performance indicator as an input. The present system inputs these pieces of input data into a multilayer neural network, and calculates an expected evaluation score for each training content. The present system outputs a list of top N content IDs having a high expected evaluation score as an output. The present system outputs data such as “content ID 101 (negotiation technique basics): score 0.9” and “content ID 205 (industry trend): score 0.85”, for example. The present system dynamically displays a recommended content on a user interface based on the output list. The present system utilizes a large language model in the generation of the role-play scenario. The present system inputs a weak point area of the sales representative (for example, “closing skill”) as a prompt. The present system outputs a dialogue script with a virtual customer and interactive scenario data including a branch condition as an output. The present system texturizes a voice input of the sales representative with a voice recognition engine, and evaluates the text with a natural language understanding model. The present system calculates a score of appropriateness of an utterance and an emotional expression as an output, and provides real-time feedback. The present system thereby provides a personalized learning experience, and dramatically improves efficiency of human resource development. The present system is applied to an education use case for an MR of a pharmaceutical company, and the like.

A communication optimization unit is a unit configured to analyze a communication history and a reaction tendency for each customer, a past response history, a personality tendency of the customer, an industry characteristic, a cultural background, and the like, and propose an optimal communication means, timing, content, and frequency using a generative AI. For example, it determines that a customer C has a better reaction by a chat than by an email, and recommends a contact by the chat. For example, since a customer D prefers a contact at the beginning of a week, it automatically transmits a follow-up email at the beginning of the week. For example, since a regular telephone follow-up is effective for a customer E, it transmits a reminder of a telephone contact to the sales representative. For example, since a customer F takes time for decision making, it proposes early information provision and a plurality of times of follow-ups. Specifically, the present communication optimization unit constructs behavior log data of the customer as a time-series tensor. The present system inputs the tensor into a recurrent neural network including an attention mechanism. The present system receives a feature amount sequence such as a past email opening time, presence or absence of a link click, and a chat reply time as input data. The present system outputs a distribution of a reaction probability for each communication channel (email, chat, telephone), and heat map data of a reaction probability for each day of the week and time zone as an output. The present system outputs numerical data such as “chat reaction probability 0.8” and “reaction probability at 10:00 a.m. on Monday 0.9”, for example. The present system automatically optimizes scheduling of message transmission based on these output results. The present system extracts a linguistic feature from a past text communication in order to estimate the personality tendency of the customer. The present system inputs the extracted feature into a personality estimation model, and outputs a score of Big Five personality traits. The present system dynamically adjusts a tone and manner of a message to be generated (for example, “logical and concise expression” or “empathetic and polite expression”) based on the output personality traits. The present system thereby maximizes engagement with the customer, and prevents an opportunity loss due to a communication mismatch. The present system is also applicable to a use case of BtoC sales of a luxury product and private banking for a wealthy class.

An interface unit is a unit configured to provide a user interface for a sales representative and a customer to access each unit on a server, and is realized in a form of a web browser, a smartphone application, a tablet application, a dedicated business terminal, and the like. For example, the sales representative confirms customer information with a smartphone from a visiting destination, and inputs feedback on the spot after a business negotiation. For example, the customer inputs its own request and a project progress from a tablet terminal. For example, a sales manager grasps an overall sales progress and a risk project on a dashboard. For example, the customer browses an FAQ and a training video. Specifically, the present interface unit adopts a single page application architecture, and realizes a high-speed screen transition on a client side. The present system asynchronously exchanges data with the present server using a RESTful API or GraphQL. The present system smoothly renders a graph including a large amount of data points utilizing a hardware acceleration technology such as WebGL in drawing of the dashboard. The present system collects heat map data of a line-of-sight movement and a mouse click of a user, and utilizes it for improvement of a user experience. The present system receives position information data acquired from a GPS sensor of a mobile terminal as an input. The present system collates the position information with location information of a customer database, and sorts and outputs a list of visitable customers around a current location in order of distance. The present system outputs data such as “customer A: distance 1.2 kilometers” and “customer B: distance 3.5 kilometers”, for example, and displays them as pins on a map interface. The present system implements a local cache mechanism using a service worker so as to operate even under an offline environment. The present system automatically synchronizes input data stored locally with the present server when a network connection is recovered. The present system thereby enables seamless business execution independent of a location and a communication environment. The present system is applied to a use case such as route sales and a visiting repair service.

As a specific example of a prompt sentence to be read by the generative AI when implementing the present invention, for example, “Please propose a product to be proposed next time and an approach method based on a past feedback and a purchase history of this customer”, “Please create a prospective customer list from business card data acquired at an exhibition, and prioritize them”, “Please summarize a complaint content from a customer, and propose three countermeasures”, “Please calculate a sales forecast for this month from data for past three years and a current project progress”, “Please automatically generate a proposal material for countering a new product announcement of a competitor”, “Please analyze a progress status and a risk factor of this project, and create an alert sentence to a related party”, “Please extract a customer list whose contract renewal timing is near, and create an optimal renewal proposal content”, “Please analyze an activity history for each sales representative, and generate an individual advice for performance improvement”, and the like are cited. Specifically, the present system includes a prompt engineering module configured to dynamically construct these prompt sentences. The present system embeds an appropriate variable into a template of a prompt according to an intention and a context of a user. The present system receives an array of transaction records for past three years extracted from a purchase history database of the customer and text data of a complaint response history as input data. The present system serializes these pieces of data into a JSON format, and combines them with a context part of the prompt. The present system dynamically adjusts a temperature parameter and a top-P value, which are inference parameters of a large language model, according to a property of a task. The present system sets the temperature parameter to 0.1 to prompt a deterministic output in a task requiring an accurate sales forecast, for example. The present system sets the temperature parameter to 0.8 to generate a diverse output in a task requiring idea generation of a proposal material. The present system receives generated text data and structured data as an output. The present system applies a post-processing filter to the output data, and detects and excludes an inappropriate expression and a hallucination (groundless output). The present system executes a feedback loop instructing recalculation when a generated sales forecast value is an abnormal value exceeding 10 times a past maximum value, for example. The present system thereby ensures reliability and safety of an output of the generative AI, and constructs a system capable of withstanding practical use in an enterprise environment. The present system is applied to a business strategy planning support use case in a corporate planning department, and the like.

### (Implementation Steps)

Step 1: Input and Accumulation of Customer Information A sales representative or a customer inputs detailed customer information such as company name, person in charge name, department, job title, contact information, industry, number of employees, capital, location, sales scale, financial information, transaction start date, transaction history, purchase history, interests, contract information, contract start date/end date, contract amount, contract condition, feedback information, questionnaire result, project progress information, shared data, training history, market insight information, past complaint history, inquiry history, customer satisfaction score, sales representative in charge history, visit history, and email and chat exchange history from a terminal, and a customer information management unit on a server centrally accumulates and manages these pieces of information in a database. For example, a case where the sales representative inputs new customer information, a case where the customer inputs their own needs or feedback, and a case where a business negotiation content or a customer reaction is input after a business negotiation are all subject to management. Specifically, the present system executes real-time data validation processing on the input customer information. The present system verifies validity of a format of a telephone number or an email address from the input text data using a regular expression. The present system collates the input company name with an API of an external corporate information database, and automatically complements missing information such as an official name, a corporate number, and a location. The present system converts the input data into a secure format using an encryption algorithm, and writes it into a distributed database. The present system performs transaction management at the time of writing data, and guarantees ACID properties of the data. The present system inputs the input text data of the business negotiation content to a natural language processing model. The present system extracts a keyword from the text, and calculates a similarity with existing customer data using a vector space model. The present system outputs a probability score that a duplicate customer record exists as an output. When the present system outputs a score of “duplicate probability 0.95”, for example, the present system activates a name identification processing module and proposes data integration. Thereby, the present system maintains accuracy and consistency of information in the database, and provides a foundation for improving accuracy of subsequent AI analysis. The present system eliminates an error caused by human manual work by automating data input, and realizes computational improvement of an information management process. The present system is applied to an input use case of a customer response history in a call center, and the like.

Step 2: Analysis of Customer Data by Generative AI A data analysis unit on the server analyzes the accumulated customer information using a generative AI, and extracts a potential need, a future sales potential, a cancellation risk, a possibility of up-selling/cross-selling, and the like for each customer. For example, the generative AI extracts a keyword and an emotion from free-text feedback of the customer using a natural language processing technology, and analyzes a purchase cycle and a transition of an order amount using time-series analysis and clustering. Specific examples of a prompt sentence to be read by the generative AI include “Please propose a product and an approach method to be proposed next time based on the past feedback and purchase history of this customer”, “Please evaluate a cancellation risk from the purchase history and questionnaire result of the customer”, and the like. Specifically, the data analysis unit generates a multidimensional tensor integrating the purchase history and the feedback text of the customer. The data analysis unit includes a hybrid neural network combining a transformer-based large language model responsible for natural language processing and a long short-term memory network processing time-series data. The data analysis unit acquires, as input data, a one-dimensional array obtained by normalizing purchase amounts for the past twelve months, and a 512-dimensional dense vector obtained by converting the feedback text into a word embedding vector. As a specific example of the input data, the data analysis unit receives an array consisting of twelve floating-point numbers indicating monthly purchase amounts, and a vector obtained by converting a text “support response is slow”. The data analysis unit combines these pieces of input data to generate a 1024-dimensional integrated feature vector. The hybrid neural network receives this integrated feature vector as an input. The hybrid neural network calculates a hidden correlation between a specific period of the purchase history and a specific word in the feedback using a self-attention mechanism. The hybrid neural network generates, as an output, a continuous value score from zero to one indicating a cancellation risk, and a probability distribution vector indicating a product category to be proposed next time. As a specific example of the output, the hybrid neural network outputs 0.85 as the cancellation risk score, and outputs a vector indicating 70% for a cloud storage expansion option and 20% for a security audit service as the probability distribution of the product category. The data analysis unit transmits these output results to a subsequent task generation module. When the cancellation risk score exceeds 0.8 which is a preset threshold value, the task generation module automatically generates an immediate follow-up task for a terminal of the sales representative in charge. With this configuration, the present system replaces the evaluation of the cancellation risk, which has relied on human intuition, with a vector operation in a high-dimensional space. Thereby, the present system realizes an improvement in processing speed by parallelizing calculation processing while ensuring objectivity of the evaluation. The present technology is extremely effective in a specific use case of improving a customer retention rate in subscription-type software sales. The hybrid neural network is pre-trained using an error backpropagation method so as to minimize a cross-entropy error function through a binary classification task using past cancellation cases as positive examples. The present system optimizes a weight parameter using an adaptive moment estimation algorithm which is a kind of a gradient descent method. The present system adopts a method of artificially synthesizing data of a minority class as a data augmentation method, and resolves an imbalance of learning data. Thereby, the present system dramatically improves inference accuracy for unknown customer data.

Step 3: Acquisition of Lead Information and External Data and Identification of Prospective Customer A sales activity support unit acquires external data such as business card data acquired at an exhibition, inquiry information via a website, reaction data on SNS, lead data via an advertisement, corporate information from an external database, industry news, and public financial information, and automatically determines a priority of a prospective customer based on a past contract pattern and a similarity with a customer attribute using a generative AI. Specific examples of a prompt sentence to be read by the generative AI include “Please create a prospective customer list from business card data acquired at an exhibition and prioritize them”, “Please extract a new lead candidate based on corporate information acquired from an external database”, and the like. Specifically, the sales activity support unit integrates a wide variety of acquired external data, and constructs a large-scale knowledge graph expressing a relationship between companies. The sales activity support unit analyzes this knowledge graph using a graph neural network. The sales activity support unit acquires, as input data, a feature vector indicating attribute information of each company, and an adjacency matrix indicating a transaction relationship and a competitive relationship between companies. As a specific example of the input data, the sales activity support unit receives a 128-dimensional numerical vector obtained by normalizing the number of employees and capital, and a binary adjacency matrix indicating a business card exchange history at an exhibition. The graph neural network executes a message passing algorithm. The graph neural network aggregates feature vectors between adjacent nodes, and updates a hidden state of each node. The graph neural network outputs, as an output, a score from zero to one indicating a probability that each company becomes a new prospective customer, and categorical data indicating a recommended approach channel. As a specific example of the output, the graph neural network outputs 0.92 as the prospective customer score for company A, and outputs an email as the recommended approach channel. The sales activity support unit transmits this output result to a subsequent list generation module. The list generation module extracts a company having a prospective customer score of 0.7 or more, and generates a prioritized list sorted in descending order of the score. With this configuration, the present system eliminates a conventional rule-based extraction method depending only on an attribute of a single company. The present system identifies a potential prospective customer with high accuracy by calculating a complex network structure between companies in a high-dimensional space. Thereby, the present system significantly reduces a search cost of the sales representative, and improves calculation efficiency of the entire system. The present technology is extremely effective in a specific use case of new market development or follow-up sales after an exhibition. The graph neural network is trained using a margin ranking loss function with a past contract record as teacher data. The present system suppresses overlearning of a model by applying a node dropout method. The present system improves a convergence speed of learning by incorporating a batch normalization layer. Thereby, the present system maintains high generalization performance even for a dynamically changing market environment.

Step 4: Automatic Task Generation and Optimization for Sales Activities A sales activity support unit analyzes a progress of sales activities, a business negotiation content, a customer reaction, competitor information, market trend information, and the like input by a sales representative using a generative AI, automatically generates an optimal timing of a next approach, a proposal content, and a sales task, and presents them to the sales representative as a ToDo list or a notification on a terminal. For example, if there is a description such as “price negotiation is difficult” or “waiting for approval of a decision maker” in a business negotiation record, the generative AI proposes an action such as presentation of a price adjustment plan or creation of an additional material for the decision maker. Specific examples of a prompt sentence to be read by the generative AI include “Please analyze a business negotiation record and generate an optimal timing and a proposal content of a next approach”, “Please list up tasks required in the future from a sales activity history”, and the like. Specifically, the sales activity support unit includes a decision-making engine integrating a reinforcement learning algorithm and a transformer model in order to analyze an action history of the sales representative and a business negotiation text. The sales activity support unit acquires, as input data, a categorical variable indicating a progress phase of a business negotiation, and a 256-dimensional text feature amount obtained by vectorizing a business negotiation memo by natural language processing. As a specific example of the input data, the sales activity support unit receives a one-hot vector indicating a “proposal stage” as the progress phase, and a dense vector obtained by converting a text “price negotiation is difficult”. The decision-making engine defines these pieces of input data as a state space. The decision-making engine defines a plurality of sales actions such as presentation of a price adjustment plan, sending of an additional material, and a direct interview request to a decision maker as an action space. The decision-making engine calculates an expected reward value of each action in a current state using a deep Q-network. The decision-making engine outputs, as an output, an identifier indicating an optimal sales action, and a time stamp indicating an optimal date and time when the action should be executed. As a specific example of the output, the decision-making engine outputs “creation of ROI material for decision maker” as the action identifier, and outputs “10:00 a.m. on the next business day” as the execution date and time. The sales activity support unit transmits this output result to a subsequent task management module. The task management module automatically registers a task in a calendar application on the terminal based on the received action identifier and time stamp. With this configuration, the present system eliminates subjective task setting based on a human rule of thumb. The present system formulates task generation as a mathematical optimization problem of reward maximization based on a past success case. Thereby, the present system improves a contract rate of sales activities, and reduces a cognitive load applied to task management. The present technology is extremely effective in a specific use case of BtoB solution sales involving complex decision-making. The deep Q-network is pre-trained by offline reinforcement learning using past business negotiation data. The present system designs a reward function that gives a positive reward to a business negotiation that has led to a contract, and gives a negative reward to a business negotiation that has been lost. The present system ensures stability of learning by using a target network and an experience replay buffer. Thereby, the present system infers an optimal next move with high accuracy even for an unknown business negotiation situation.

Step 5: Sales Forecasting, Competitive Analysis, and Sales Strategy Proposal A sales activity support unit comprehensively analyzes past business negotiation data, a current project progress, a customer purchase tendency, an industry trend, a seasonal factor, competitor product information and price information, a news article, an SNS post, a past lost order reason, a competitor sales strategy analysis, and the like using a generative AI, and automatically calculates and proposes a sales prospect for this month, a target achievement probability for a next term, a sales tendency of a specific customer group, a correction proposal for a sales strategy based on a competitive trend, and the like. Specific examples of a prompt sentence to be read by the generative AI include “Please calculate a sales forecast for this month from sales data for the past three years and a current project progress”, “Please propose a sales strategy to counter a new product announcement of a competitor”, and the like. Specifically, the sales activity support unit includes a prediction model combining a one-dimensional convolutional neural network and a self-attention mechanism in order to simultaneously process multivariate time-series data and unstructured text data. The sales activity support unit acquires, as input data, a multidimensional time-series tensor including monthly sales for the past thirty-six months, a project progress rate, and an emotion score extracted from a news article of a competitor. As a specific example of the input data, the sales activity support unit receives an array of continuous values indicating monthly sales, an array of integer values from zero to one hundred indicating a project progress rate, and an array of emotion scores from minus one to plus one calculated from a news article. The prediction model extracts a local trend feature of time-series data using a one-dimensional convolutional layer. The prediction model calculates a long-term influence degree that a specific past event has on current sales using a self-attention layer. The prediction model outputs, as an output, a continuous value indicating predicted sales for a next month, and a percentage value indicating a target achievement probability. As a specific example of the output, the prediction model outputs 50 million yen as the predicted sales, and outputs 85% as the target achievement probability. The sales activity support unit transmits this output result to a subsequent strategy proposal module. When the target achievement probability falls below 50%, the strategy proposal module refers to price information of a competitor, and automatically generates an implementation plan of a discount campaign. With this configuration, the present system eliminates a conventional sales forecasting method based on simple linear regression. The present system models a non-linear market fluctuation and a competitive trend in a high-dimensional feature space. Thereby, the present system significantly reduces a prediction error, and supports decision-making of a management layer. The present technology is extremely effective in a specific use case of quarterly sales target management or management strategy formulation. The prediction model is optimized through supervised learning on a past data set using a mean square error as a loss function. The present system prevents overlearning for noisy market data by applying a dropout layer and L2 regularization. The present system adopts cosine annealing as a learning rate scheduling method, and avoids falling into a local optimal solution. Thereby, the present system realizes highly accurate and stable sales forecasting.

Step 6: Automatic Generation of Proposal Materials and Documents A proposal material generation unit automatically creates a proposal template, a customized proposal material, a competitive comparison table, an ROI simulation, an introduction case collection, an FAQ collection, a price simulation material, and the like based on an attribute for each customer, a past proposal content, a competitive situation, a customer interest field, an industry trend, and the like using a generative AI, and enables editing and outputting on a terminal. Specific examples of a prompt sentence to be read by the generative AI include “Please generate a proposal draft for customer A”, “Please create a proposal material including a competitive comparison table and an ROI simulation”, and the like. Specifically, the proposal material generation unit includes a multimodal generation engine integrating a large language model and a generative adversarial network in order to dynamically construct a document matching a customer-specific requirement. The proposal material generation unit acquires, as input data, a text prompt indicating an industry and an issue of a customer, and a structured JSON object including specification data of a product to be proposed. As a specific example of the input data, the proposal material generation unit receives a text prompt “cost reduction proposal for manufacturing industry”, and a set of key-value pairs indicating a price and a specification of a product. The multimodal generation engine generates a configuration plan and an explanatory text of each slide of a proposal from the input text prompt using a large language model. The multimodal generation engine automatically generates an infographic and a graph image matching a content of the explanatory text using a generative adversarial network. The multimodal generation engine outputs, as an output, a binary file in a presentation format in which a text and an image are arranged, and spreadsheet data including an ROI simulation result. As a specific example of the output, the multimodal generation engine outputs slide data consisting of ten pages, and outputs a numerical matrix indicating a return on investment for five years. The proposal material generation unit transmits these output results to a subsequent interface unit. The interface unit displays a preview of the generated file on a browser on the terminal, and accepts a final adjustment by a sales representative. With this configuration, the present system eliminates a conventional document creation process in which a human manually edits a template. The present system instantaneously generates a highly personalized proposal material by combining natural language processing and an image generation technology. Thereby, the present system dramatically reduces a time required for material creation, and provides an environment in which the sales representative can concentrate on a dialogue with the customer. The present technology is extremely effective in a specific use case of a proposal of complex system integration or sales of a customized product. The large language model is fine-tuned using past excellent proposal data as a corpus. The present system improves persuasiveness and accuracy of a generated text using a human feedback method from reinforcement learning. The present system uses a heuristic constraint satisfaction algorithm in combination in order to optimize a layout of the generated material. Thereby, the present system stably outputs a visually excellent and logical proposal material.

Step 7: Feedback Collection and Analysis and Needs Collection and Analysis from Customer A customer relationship strengthening unit analyzes feedback, a request, a questionnaire result, an inquiry content, and the like input from a customer through a terminal using a generative AI, automatically classifies them into a positive opinion, an improvement request, a complaint, a new function request, dissatisfaction with a price, an evaluation of a support system, and the like, and proposes a prompt response and a specific action to a sales representative. Specific examples of a prompt sentence to be read by the generative AI include “Please summarize a feedback content from a customer and propose three countermeasures”, “Please extract a main need of a customer from a questionnaire result”, and the like. Specifically, the customer relationship strengthening unit includes a pre-trained language model based on bidirectional encoder representations in order to extract deep psychology of the customer from unstructured text data. The customer relationship strengthening unit acquires, as input data, a feedback text transmitted from the customer, and a text array including a past inquiry history of the customer. As a specific example of the input data, the customer relationship strengthening unit receives a 50-character text “interface of new function is difficult to use”, and log data of support chats for past three times. The language model tokenizes the input text, and converts each token into a 768-dimensional embedding vector. The language model calculates self-attention considering a context using a multi-layer transformer encoder, and generates a semantic representation vector of the entire text. The language model outputs, as an output, a probability distribution vector indicating a category of feedback, and a continuous value score from minus one to plus one indicating a polarity of an emotion. As a specific example of the output, the language model outputs a vector indicating a probability of 90% for “improvement request” as the category, and outputs minus 0.6 as the emotion polarity score. The customer relationship strengthening unit transmits these output results to a subsequent action proposal module. When the emotion polarity score falls below minus 0.5, the action proposal module determines that a dissatisfaction degree of the customer is high, and automatically transmits an alert instructing an emergency response to a manager of a support department. With this configuration, the present system eliminates a conventional text classification method depending on keyword matching. The present system detects irony and implicit dissatisfaction with high accuracy by analyzing a context in a high-dimensional space. Thereby, the present system reduces a cancellation risk due to a delay in customer response, and improves customer satisfaction. The present technology is extremely effective in a specific use case of a large-scale customer support center or cancellation prevention of a subscription service. The language model is pre-trained with millions of general text data, and then fine-tuned using a domain-specific corpus including a specific industry term and product name. The present system optimizes a weight of a classification layer using a cross-entropy error function. The present system prevents gradient explosion during learning and ensures stability of a model by applying a gradient clipping method. Thereby, the present system exhibits robust analysis performance for diverse customer expressions.

Step 8: Project, Contract, and Data Sharing Management A project management unit and a contract management unit centrally manage a progress of a joint project with a customer, a task, a person in charge, a delivery date, resource allocation, a risk factor, a request change from the customer, a contract content and a renewal timing, a past negotiation history, a contract condition change history, a payment status, a contract violation risk, and the like, and perform detection and reminder of a progress delay, early discovery of a risk factor, prioritization of a task, optimization of resource allocation, automatic notification before contract expiration, timing proposal of price revision negotiation, risk evaluation at the time of contract condition change, automatic detection of an unpaid risk, and the like using a generative AI. Specific examples of a prompt sentence to be read by the generative AI include “Please analyze a project progress status and a risk factor, and create an alert text to a related party”, “Please extract a customer list whose contract renewal timing is near, and create an optimal renewal proposal content”, and the like. Specifically, the project management unit and the contract management unit include an anomaly detection engine combining an autoencoder and a long short-term memory network in order to integrally monitor a progress status of a complex project and a contract risk. The project management unit acquires, as input data, a numerical vector indicating a difference between a scheduled man-hour and an actual man-hour of each task, and a time-series array indicating an operation rate of a resource. As a specific example of the input data, the project management unit receives a floating-point number obtained by normalizing the number of task delay days, and an array of percentage values indicating a weekly operation rate of an engineer. The anomaly detection engine learns a dynamic change pattern of time-series data using a long short-term memory network, and constructs a low-dimensional latent representation of a normal project progress state using an autoencoder. The anomaly detection engine calculates a reconstruction error when reconstructing the input data. The anomaly detection engine outputs, as an output, an anomaly score from zero to one hundred indicating a delay risk of a project, and a contribution degree vector of a feature amount indicating a main factor of the risk. As a specific example of the output, the anomaly detection engine outputs 85 as the anomaly score, and outputs an index indicating that “overload of specific engineer” is the maximum factor in the contribution degree vector. The project management unit transmits these output results to a subsequent resource optimization module. When the anomaly score exceeds 70 which is a threshold value, the resource optimization module generates an automatic allocation plan of an alternative resource based on the contribution degree vector, and presents it to a terminal of a project manager. With this configuration, the present system eliminates a conventional progress management method in which a human visually checks a Gantt chart. The present system adopts a mathematical anomaly detection approach based on a reconstruction error of multivariate time-series data. Thereby, the present system discovers a potential delay risk at an early stage, and dramatically improves a success probability of a project. The present technology is extremely effective in a specific use case of management of a large-scale system development project or a long-term consulting contract. The autoencoder is trained by unsupervised learning so as to minimize a mean square error using data of a past successful project as normal data. The present system enhances expressive power of a latent representation by adding a sparse regularization term to a loss function. The present system applies similar time-series analysis also in prediction of a contract renewal timing, detects a decrease in a usage frequency of a customer, and automatically triggers a retention measure. Thereby, the present system realizes advanced automation in both aspects of project management and contract management.

Step 9: Provision of Training and Knowledge and Communication Optimization A training provision unit automatically selects an optimal teaching material, video, FAQ, case study, role-play scenario, and the like by a generative AI according to a skill and an interest field of a sales representative and a customer, a past training history, a sales performance, and a feedback content, and enables viewing on a terminal. In addition, a communication optimization unit analyzes a communication history and a reaction tendency for each customer, a past response history, a personality tendency of the customer, an industry characteristic, a cultural background, and the like, and proposes an optimal communication means, timing, content, and frequency using a generative AI. Specific examples of a prompt sentence to be read by the generative AI include “Please analyze an activity history for each sales representative and generate individual advice for performance improvement”, “Please propose an optimal communication means and timing to customer C”, and the like. Specifically, the training provision unit and the communication optimization unit include a personalization engine integrating deep collaborative filtering and reinforcement learning in order to provide a content and a dialogue strategy tailored to a characteristic of each user. The training provision unit acquires, as input data, a sparse binary vector indicating a past training history of the sales representative, and a continuous value vector indicating a latest sales performance. As a specific example of the input data, the training provision unit receives a 100-dimensional vector in which one is set for a trained material among 100 types of teaching materials, and a numerical value indicating a monthly achievement rate. The personalization engine learns a non-linear interaction between a user feature vector and an item feature vector using a multilayer perceptron. The personalization engine outputs, as an output, an array of predicted evaluation scores from zero to one indicating a recommendation degree for each teaching material. As a specific example of the output, the personalization engine outputs a score of 0.95 for a teaching material “advanced negotiation skill”, and outputs a score of 0.2 for “basic product knowledge”. The training provision unit transmits this output result to a subsequent display control module. The display control module extracts top three teaching materials in the predicted evaluation score, and preferentially displays them on a dashboard of the terminal. With this configuration, the present system eliminates a conventional education method of providing uniform training to all employees. The present system maps an individual skill gap and learning tendency in a high-dimensional space, and dynamically generates an optimal learning path. Thereby, the present system maximizes learning efficiency, and raises sales capability of the entire organization. The present technology is extremely effective in a specific use case of human resource development in a sales organization of a scale of several thousand people, or engagement improvement for each customer. The personalization engine is trained using a binary cross-entropy loss function with correlation data between a past training history and performance improvement as teacher data. The present system adopts a hybrid approach using content-based recommendation based on attribute information in combination for a new user in order to cope with a cold start problem. The present system constructs a Markov decision process model using a reaction rate of a customer as a reward also in communication optimization, and continuously optimizes an optimal email transmission time and text tone by reinforcement learning. Thereby, the present system realizes a self-evolving platform that continuously improves a user experience.

Step 10: Provision of Dashboard, Alert, and Report An interface unit provides a user interface for a sales representative and a customer to access each unit on a server, and enables viewing, editing, and inputting of a sales task, a proposal material, a progress report, a feedback result, a training content, contract information, a communication proposal, a project management screen, a dashboard, an alert notification, an FAQ, a knowledge base, and the like in a form of a web browser, a smartphone application, a tablet application, a dedicated business terminal, and the like. For example, various operations are possible, such as a sales manager grasping overall sales progress and a risk project on the dashboard, the sales representative receiving the alert notification and immediately responding, the customer viewing the FAQ and a training video, and the sales representative checking customer information with a smartphone from an outside location and inputting feedback on the spot after a business negotiation. Specifically, the interface unit includes a data distribution architecture integrating a real-time stream processing engine and edge computing technology in order to process a huge data stream without delay and provide it as intuitive visual information. The interface unit acquires, as input data, a group of event messages in JSON format asynchronously transmitted from each unit on the server, and metadata indicating position information and a device state acquired from a sensor of a terminal. As a specific example of the input data, the interface unit receives an event message indicating an update of a sales forecast, and GPS coordinate data transmitted from the smartphone of the sales representative. The stream processing engine aggregates and filters these pieces of input data in milliseconds by utilizing an in-memory database. The stream processing engine outputs, as an output, an optimized structured data set for dashboard drawing, and a payload for push notification according to an urgency level. As a specific example of the output, the stream processing engine outputs an array of time-series data points for graph drawing, and outputs a payload of an emergency alert indicating occurrence of a complaint from a major customer. The interface unit push-distributes these output results to each terminal via secure WebSocket communication. An application on the terminal side renders a smooth three-dimensional graph and a heat map by WebGL technology using the received data set. With this configuration, the system eliminates a conventional data update method depending on periodic batch processing. The system minimizes latency from data generation to screen display by adopting an event-driven architecture. Thereby, the system enables the sales manager and the representative to always make a quick decision based on the latest situation. The present technology is extremely effective in specific use cases of agile sales activities under an ever-changing market environment and real-time monitoring in a large-scale call center. The system adopts virtual DOM technology for receiving only difference data and updating a screen on the terminal side in order to save a communication band. The system implements an offline-first design providing a local cache and a synchronization queue on the terminal side so that operation can be continued even under an environment where network connection is unstable. Thereby, the system provides a seamless and comfortable user experience even from a smartphone at an outside location.

### (Specific Use Case)

For example, when a corporate sales representative performs discovery of a new prospective customer and planning of an approach strategy, the sales representative inputs business card data acquired at an exhibition, inquiry information via a website, reaction data on SNS, corporate information from an external database, and the like from a terminal to a customer information management unit. A sales activity support unit centrally accumulates these pieces of data, and gives a generative AI a prompt “Please create a prospective customer list and prioritize it based on the business card data acquired at the exhibition and past contract patterns.” The generative AI comprehensively analyzes attributes, business negotiation history, industry, corporate scale, job title of a person in charge, past purchasing tendency, and the like of past contracted projects, scores a contract probability for each prospective customer, and automatically generates a prioritized list. The sales representative can check this list on the terminal and plan an approach plan in order from a prospective customer with high priority. Specifically, the sales activity support unit includes an ensemble learning model combining a graph neural network and a random forest in order to extract a promising prospective customer from heterogeneous data sources with high accuracy. The sales activity support unit acquires, as input data, a text feature amount including a job title and a department name extracted from the business card data, and a numerical vector including a financial indicator of a company acquired from the external database. As a specific example of the input data, the sales activity support unit receives a 300-dimensional array obtained by vectorizing a job title “Information System Manager”, and a 5-dimensional numerical array indicating a sales growth rate and an operating profit margin. The ensemble learning model calculates a centrality score in a transaction network between companies using the graph neural network, and calculates a contract probability based on attribute data using the random forest. The ensemble learning model outputs, as an output, a comprehensive contract probability score from 0 to 100 for each prospective customer, and a feature amount importance vector indicating a basis of the score. As a specific example of the output, the ensemble learning model outputs 88 as the contract probability score, and outputs a vector indicating that “past introduction track record in a peer company” contributes most as the feature amount importance. The sales activity support unit transmits this output result to a subsequent list generation module. The list generation module extracts a prospective customer whose contract probability score exceeds 70 which is a preset threshold, and generates an approach list sorted in order of score. With this configuration, the system eliminates a conventional prospective customer selection process depending on intuition and experience of the sales representative. The system offsets a bias of a single model and dramatically improves prediction accuracy by integrating a plurality of machine learning algorithms. Thereby, the system enables sales resources to be concentrated on a prospective customer with the highest return on investment. The present technology is extremely effective in specific use cases of processing a large amount of leads after a large-scale exhibition and creating a target list for a new business. The ensemble learning model is trained to minimize a cross-entropy error using both past contract data and lost order data. The system automatically adjusts a depth and a number of decision trees of the random forest using Bayesian optimization which is a hyperparameter optimization method. The system applies an imputation algorithm using a K-nearest neighbor method to a missing value of the feature amount to ensure data integrity. Thereby, the system executes robust inference even for incomplete external data.

Also, when the sales representative considers an upsell proposal to an existing customer, the generative AI is caused to analyze past purchase history, feedback information, inquiry history, questionnaire results, contract information, and the like accumulated in the customer information management unit with a prompt “Please propose a product or service effective for upselling based on the past purchase history and feedback content of this customer.” The generative AI extracts a usage status of a product purchased by the customer in the past, a request and an issue included in the feedback, an interest field included in the inquiry content, a future investment intention indicated in the questionnaire, and the like, and automatically generates an optimal upsell proposal content for each customer. The sales representative can create a proposal document and an email text to the customer based on this proposal content, and transmit them from the terminal. Specifically, the customer information management unit includes a self-attention recommendation model based on a transformer architecture in order to generate an optimal additional proposal that arouses a potential purchasing motivation of the customer. The customer information management unit acquires, as input data, a sequence of item IDs in which the past purchase history of the customer is arranged in chronological order, and an embedding vector of a keyword extracted from a feedback text. As a specific example of the input data, the customer information management unit receives an integer array indicating IDs of three products purchased in the past, and a 256-dimensional vector obtained by converting a keyword “security enhancement”. The recommendation model simultaneously calculates a dependency relationship between past purchased items and a semantic relevance with the feedback keyword using a self-attention mechanism. The recommendation model outputs, as an output, a probability distribution vector indicating an upsell recommendation degree for all products in a catalog, and a natural language text snippet explaining a reason for the proposal. As a specific example of the output, the recommendation model outputs a vector indicating that a probability of a “premium support plan” as a top product is 80%, and outputs a text “based on inquiry history regarding past security incidents” as the proposal reason. The customer information management unit transmits these output results to a subsequent proposal document generation module. The proposal document generation module inserts information of a product with the highest probability into a template, and automatically generates a draft proposal document for the sales representative. With this configuration, the system eliminates a simple rule-based cross-sell proposal method. The system realizes context understanding in a high-dimensional space integrating customer behavior history and unstructured text. Thereby, the system enables a persuasive upsell proposal directly linked to a current issue of the customer, and improves a customer unit price. The present technology is extremely effective in specific use cases of a plan upgrade of a cloud service and an expansion proposal of a maintenance contract. The recommendation model is pre-trained using a contrastive learning framework with a past successful upsell case as a positive example and a negative example generated using a negative sampling method. The system uses an Adam optimizer for updating weights of the model, and applies a warmup schedule of a learning rate, thereby eliminating instability in an initial stage of learning. The system generates the most natural and logical proposal reason text using a beam search algorithm during inference. Thereby, the system provides high-quality proposal content that the sales representative can present to the customer as it is.

Furthermore, the sales activity support unit gives the generative AI a prompt “Please calculate a sales forecast for this month from data for the past three years and current project progress” based on activity history and business negotiation progress of the sales representative, competitor information, and market trend information, whereby the generative AI comprehensively analyzes past sales transition, a progress degree of a currently ongoing project, a purchasing cycle of the customer, a seasonal factor of the industry, a trend of a competitor, and the like, and digitizes and outputs a sales prospect for this month, a target achievement probability, and a risk factor. The sales manager can check this sales forecast on the dashboard, and perform correction of a sales strategy and review of resource allocation as necessary. Specifically, the sales activity support unit includes a hybrid prediction engine integrating a time-series prediction algorithm and a long short-term memory network in order to realize highly accurate future prediction considering a complex market factor. The sales activity support unit acquires, as input data, a one-dimensional time-series array including daily sales data for the past 36 months, and a multidimensional matrix including an order probability and an expected amount of each currently ongoing project. As a specific example of the input data, the sales activity support unit receives an array consisting of 1080 floating-point numbers indicating daily sales amounts, and a 50-row 3-column matrix including data of 50 ongoing projects. The hybrid prediction engine decomposes a seasonality and a trend component of the sales data using the time-series prediction algorithm, and learns a non-linear change pattern of project progress using the long short-term memory network. The hybrid prediction engine outputs, as an output, a time-series array indicating a daily sales forecast value for the next three months, and an upper limit value and a lower limit value of a 95% confidence interval indicating uncertainty of prediction. As a specific example of the output, the hybrid prediction engine outputs 100 million yen as a predicted sales at the end of the month, and outputs a numerical value indicating a range from 90 million yen to 110 million yen as the confidence interval. The sales activity support unit transmits these output results to a subsequent dashboard control module. The dashboard control module displays a red alert icon on a screen to call attention to the manager when a probability that the predicted sales falls below a target value exceeds 30%. With this configuration, the system eliminates a conventional sales forecasting method depending on subjective reading of the sales representative. The system mathematically integrates a past statistical trend and a current pipeline situation, and provides objective and quantitative prediction. Thereby, the system enables a management layer to perform quick trajectory correction and resource reallocation based on data. The present technology is extremely effective in specific use cases of improving accuracy of a landing prospect for a quarterly financial settlement and optimizing a production plan based on demand forecasting in a manufacturing industry. The hybrid prediction engine is trained using a backpropagation through time algorithm so as to minimize a past prediction error. The system applies robust scaling preprocessing to the input data in order to reduce an influence of an outlier. The system uses a mean absolute percentage error as an evaluation index of a prediction model, and automatically executes retraining of the model periodically. Thereby, the system continues to maintain prediction accuracy even against a rapid change in a market environment.

Also, the customer relationship strengthening unit causes the generative AI to analyze feedback, a request, and a questionnaire result input from the customer through the terminal with a prompt “Please summarize feedback content from the customer and propose three countermeasures”, whereby the generative AI automatically classifies the feedback content into a positive opinion, an improvement request, a complaint, a new function request, dissatisfaction with price, evaluation of a support system, and the like, and proposes a quick countermeasure and a specific action (for example, apology response, feedback transfer to a new function development department, consideration of price review, proposal for strengthening the support system, and the like) to the sales representative. The sales representative can quickly and accurately implement customer response based on these proposals. Specifically, the customer relationship strengthening unit includes a text analysis engine combining topic modeling based on latent Dirichlet allocation and a large language model in order to extract a practical insight from a large amount of unstructured text. The customer relationship strengthening unit acquires, as input data, a feedback text of several hundred characters transmitted from the customer, and a categorical variable indicating attribute information of the customer. As a specific example of the input data, the customer relationship strengthening unit receives a text “System response speed is slow, causing trouble in business”, and an identifier indicating that a contract plan of the customer is “Enterprise”. The text analysis engine extracts a latent topic distribution from a text group using topic modeling, and analyzes a context and an emotion polarity of the text using the large language model. The text analysis engine outputs, as an output, a classification label indicating a category to which the feedback belongs, and a natural language text array indicating a candidate for a specific countermeasure. As a specific example of the output, the text analysis engine outputs “serious complaint” as the classification label, and outputs three texts “immediate escalation to technical department”, “temporary enhancement of server resources”, and “transmission of primary apology email to customer” as the countermeasure. The customer relationship strengthening unit transmits these output results to a subsequent workflow management module. When the classification label is “serious complaint”, the workflow management module bypasses a normal approval process and immediately adds a response instruction to a task queue of the technical department. With this configuration, the system eliminates a conventional process in which a human manually classifies a questionnaire and considers a response. The system accurately understands an intention of the text using natural language processing technology, and instantly derives an optimal action. Thereby, the system dramatically shortens a lead time of customer response and prevents occurrence of a secondary complaint. The present technology is extremely effective in specific use cases of operation of a large-scale customer support center and acceleration of a user feedback loop of a SaaS product. The large language model is optimized by an instruction tuning method using past excellent customer support response history as a corpus. The system adopts byte pair encoding which is a subword division algorithm in tokenization of text, and enhances robustness against an unknown word. The system incorporates an autoregressive scoring mechanism in order to evaluate validity of the generated countermeasure. Thereby, the system always proposes a safe and appropriate customer response action.

Furthermore, a project management unit centrally manages progress of a joint project with the customer, a task, a person in charge, a delivery date, resource allocation, a risk factor, a request change from the customer, and the like, and gives the generative AI a prompt “Please analyze a project progress situation and a risk factor, and create an alert text to a related party”, whereby the generative AI automatically detects a progress delay and a risk factor, and automatically generates an appropriate alert and reminder to the related party. Thereby, a delay and a trouble of the project can be prevented in advance, and customer satisfaction can be improved. Specifically, the project management unit includes a risk inference engine integrating a Bayesian network and a recurrent neural network in order to quantify uncertainty of a complexly intertwined project and specify a potential failure risk at an early stage. The project management unit acquires, as input data, time-series data of a binary vector indicating a completion status of each task, and a continuous value matrix indicating working hours of a project member. As a specific example of the input data, the project management unit receives an array of 0 and 1 indicating a task completion situation for the past two weeks, and a matrix of floating-point numbers indicating daily overtime hours of each member. The risk inference engine extracts a hidden state vector from the time-series data using the recurrent neural network, and executes probabilistic inference based on a dependency relationship between tasks using the Bayesian network. The risk inference engine outputs, as an output, a continuous value score from 0 to 1 indicating a probability that the project is delayed to the delivery date, and a task ID on a critical path which is a root cause of the delay. As a specific example of the output, the risk inference engine outputs 0.82 as the delay probability score, and outputs an ID of “database design phase” as the root cause task. The project management unit transmits these output results to a subsequent alert generation module. When the delay probability score exceeds 0.7 which is a threshold, the alert generation module automatically transmits a warning message including the ID of the root cause task and a recommended resource addition plan to a terminal of the related party. With this configuration, the system eliminates a conventional risk management method depending on a rule of thumb of a project manager. The system mathematically simulates a ripple effect that a delay of a task gives to a subsequent task using a probabilistic model. Thereby, the system enables taking a proactive measure before a problem surfaces, and improves a success rate of the project. The present technology is extremely effective in specific use cases of a large-scale system integration project and progress management of a construction project involving a plurality of vendors. The recurrent neural network uses past project history data as teacher data, and weights are optimized using a backpropagation through time method. The system estimates a posterior probability distribution using a Markov chain Monte Carlo method in structure learning of the Bayesian network. The system incorporates a variational autoencoder based on a Gaussian distribution as a preprocessing step in order to enhance tolerance to noise of the input data. Thereby, the system realizes highly accurate risk prediction even from incomplete progress report data.

Also, a contract management unit manages contract content, renewal timing, past negotiation history, contract condition change history, payment status, contract violation risk, and the like, and gives the generative AI a prompt “Please extract a list of customers whose contract renewal timing is near, and create an optimal renewal proposal content”, whereby the generative AI analyzes a contract expiration date, past negotiation history, purchasing tendency of the customer, payment status, and the like, and automatically generates contract renewal timing, optimal proposal content, a price revision plan, a condition change plan, and the like. The sales representative can smoothly proceed with contract renewal negotiation based on this information. Specifically, the contract management unit includes a contract optimization engine integrating a survival time analysis model and a transformer-based generative model in order to predict a churn risk of the customer and derive an optimal retention measure. The contract management unit acquires, as input data, time-series event data indicating past contract renewal history of the customer, and a numerical vector indicating a service usage frequency for the latest six months. As a specific example of the input data, the contract management unit receives an array of contract renewal dates and contract amounts for the past five times, and a 10-dimensional numerical vector indicating the number of monthly logins and the number of function uses. The contract optimization engine calculates a hazard rate at which each customer rejects next renewal using a Cox proportional hazards model which is a survival time analysis model. The contract optimization engine generates an optimal proposal condition for lowering the hazard rate using the transformer model. The contract optimization engine outputs, as an output, a percentage value indicating a success probability of contract renewal, and structured data of proposal content including a price discount rate and an additional option. As a specific example of the output, the contract optimization engine outputs 60% as the renewal success probability, and outputs JSON data indicating “5% discount on basic charge” and “3-month free attachment of premium support” as the proposal content. The contract management unit transmits these output results to a subsequent document generation module. The document generation module automatically inserts the received proposal content into an invitation template for contract renewal, and places it in a confirmation waiting queue of the sales representative. With this configuration, the system eliminates a conventional uniform approach of sending a uniform renewal invitation to all customers. The system analyzes a usage status and a churn risk for each customer in a high-dimensional space, and dynamically generates an individually optimized offer. Thereby, the system maximizes a contract renewal rate and a lifetime customer value while suppressing an unnecessary discount. The present technology is extremely effective in specific use cases of improvement of a churn rate in a SaaS business and improvement of a continuation rate of a maintenance service. The survival time analysis model treats data of past canceled customers and continued customers as right-censored data, and is trained to maximize a partial likelihood function. The system uses proximal policy optimization which is a reinforcement learning algorithm in learning of the transformer model, and sets a reward function that optimizes a trade-off between a profit margin and a renewal rate. The system incorporates reaction data at the time of past price change into the model as a covariate in order to estimate price sensitivity of the customer. Thereby, the system calculates an optimal proposal condition without impairing profitability.

Furthermore, a training provision unit gives the generative AI a prompt “Please analyze activity history for each sales representative and generate individual advice for performance improvement” according to a skill and an interest field of the sales representative and the customer, past training history, sales performance, and feedback content, whereby the generative AI analyzes a strength/weakness and an activity tendency for each sales representative, and a past success case and failure case, and automatically generates an individually optimized training plan, teaching material, and advice. The sales representative can perform self-improvement based on this advice, and aim at improvement of sales capability. Specifically, the training provision unit includes an adaptive learning engine integrating a knowledge graph and deep reinforcement learning in order to specify a skill gap of each sales representative and dynamically construct an optimal learning path. The training provision unit acquires, as input data, a performance vector indicating a win rate and an average order unit price in past business negotiations of the sales representative, and an ID array of training modules taken in the past. As a specific example of the input data, the training provision unit receives a 5-dimensional numerical vector indicating a win rate of 40% and an average order unit price of 3 million yen, and an integer array indicating five teaching material IDs already taken. The adaptive learning engine maps a semantic relevance between a sales skill and each training material using the knowledge graph. The adaptive learning engine calculates an optimal presentation order of teaching materials for transitioning from a current performance state to a target state using a deep reinforcement learning agent. The adaptive learning engine outputs, as an output, an ID of a recommended teaching material to be taken next, and a predicted value indicating an improvement width of a win rate expected by taking the teaching material. As a specific example of the output, the adaptive learning engine outputs “advanced objection handling technique” as the recommended teaching material ID, and outputs plus 5% as the expected win rate improvement width. The training provision unit transmits these output results to a subsequent user interface control module. The user interface control module highlights and displays the recommended teaching material at the top of a learning dashboard of the sales representative, and transmits a notification prompting taking. With this configuration, the system eliminates a conventional static training program forcing a fixed curriculum on all employees. The system provides a personalized learning experience in real time based on an individual weakness and learning history. Thereby, the system creates a direct business result of improvement of sales performance while minimizing time required for learning. The present technology is extremely effective in specific use cases of shortening an onboarding period in a large-scale sales organization and continuous skill-up support. The deep reinforcement learning agent receives improvement of sales performance as a reward and updates a Q-value in a learning environment formulated as a Markov decision process. The system adopts an epsilon-greedy method and continuously tests effectiveness of an unknown teaching material in order to solve a dilemma of exploration and exploitation. The system automatically extracts an entity and a relationship from an in-house sales manual and a success case collection using natural language processing in construction of the knowledge graph. Thereby, the system always provides advanced training reflecting the latest in-house know-how.

In this way, the system of the present invention realizes data analysis, automatic proposal, task generation, document creation, risk detection, communication optimization, training provision, and the like utilizing the generative AI in all business processes at a sales site, and can comprehensively support business efficiency improvement of the sales representative and the customer, sophistication of decision making, customer satisfaction improvement, competitiveness strengthening, and construction of a continuous business relationship. Specifically, the system includes a distributed processing infrastructure based on a microservices architecture in order to integrally orchestrate the plurality of artificial intelligence modules described above and ensure scalability and fault tolerance of the entire system. The system acquires, as input data, a huge amount of transaction data asynchronously generated from each business process, and telemetry data indicating a resource usage status of each module. As a specific example of the input data, the system receives log data including thousands of API requests per second, and time-series metrics indicating a CPU usage rate and memory consumption of each container. The distributed processing infrastructure controls communication between microservices using service mesh technology, and dynamically routes traffic using a load balancing algorithm. The distributed processing infrastructure outputs, as an output, a control command instructing scale-out or scale-in of each container, and a health check score indicating soundness of the entire system. As a specific example of the output, the distributed processing infrastructure outputs a control command to increase the number of replicas of a data analysis module from 3 to 5, and outputs 99.9% as the health check score. The system transmits these output results to a subsequent container orchestration engine. The container orchestration engine activates a new container instance in milliseconds based on the control command, and enhances processing capability. With this configuration, the system eliminates a conventional monolithic system architecture having a single point of failure. The system enables each artificial intelligence module to be independently deployed and scaled, and maintains stable response performance even at the time of high load. Thereby, the system maximizes utilization efficiency of computing resources and reduces an operation cost of infrastructure. The present technology is extremely effective in a specific use case of operation of a global-scale enterprise platform accessed by tens of thousands of users simultaneously. The system adopts an event sourcing pattern and a command query responsibility segregation pattern in order to guarantee data consistency between respective modules. The system constructs an automated MLOps pipeline in order to realize continuous integration and continuous delivery of a machine learning model. When detecting that inference accuracy of the model has decreased, the system automatically triggers a retraining process using the latest data set. Thereby, the system continues to always provide an artificial intelligence model with the highest performance to a production environment.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

An embodiment for carrying out the present invention is a logistics center operation support system composed of a server and a plurality of terminals, and comprises a package information management unit, a worker management unit, an equipment management unit, a scheduling optimization unit, a delivery route optimization unit, an education plan proposal unit, a customer response proposal unit, and a trouble sign detection unit. Each unit is mainly realized on the server, and the terminal functions as an interface used by a field worker, an administrator, an equipment person in charge, a customer response person in charge, and the like. Specifically, the logistics center operation support system includes a hybrid distributed processing architecture in which edge computing and cloud computing are linked in order to integrally process a huge amount of logistics data and a dynamic situation of a site in real time. The system acquires, as input data, high-frequency stream data transmitted from each terminal and an IoT sensor at the site, and structured data including external traffic information and weather information. As a specific example of the input data, the system receives position coordinate data ten times per second from a sensor mounted on a forklift, and numerical data of a precipitation probability and a wind speed acquired from an API of the Japan Meteorological Agency. The system executes primary filtering and compression of data at an edge node, and transfers the data to a main server on a cloud. The server processes the received large-scale data using a parallel computing cluster equipped with a plurality of graphics processing units. The server outputs, as an output, a synchronization control signal for each subsystem and a JSON data set for an integrated dashboard indicating an operating status of the entire system. As a specific example of the output, the server outputs a control signal for a route change to an automatic transfer robot, and outputs numerical data indicating a package processing throughput of the entire center. The system transmits these output results to each terminal and control device via a low-latency network. With this configuration, the system eliminates a conventional centralized architecture in which all processing loads are concentrated on a central server. The system optimally shares immediate processing on an edge side and advanced machine learning inference on a cloud side. Thereby, the system realizes a response speed in milliseconds to a physical change at the site while suppressing consumption of a network bandwidth. The present technology is extremely effective in a specific use case of complete automation of a large-scale mega-logistics center in which tens of thousands of packages move continuously. The system implements each management unit as an independent microservice using a containerization technology, and dynamically scales out according to a load. The system adopts a gRPC protocol for communication between services, and minimizes an overhead of data serialization. The system includes a redundant configuration that automatically executes a failover when a failure occurs. Thereby, the system guarantees stable operation without stopping 24 hours a day, 365 days a year.

The package information management unit registers, accumulates, and manages in detail, for all packages carried into the logistics center, a package ID, a package type, a weight, a size, a storage temperature condition, a scheduled warehousing date, a scheduled delivery date, a delivery destination, a priority, special handling information (for example, refrigerated/frozen, dangerous goods, high-priced goods, fragile items, and the like), a warehousing and delivery history, a past trouble history, barcode and RFID tag information, a packing state, shipper information, delivery company information, photograph data of the package, storage area information, a transfer history, an inspection result, a damage/stain record, an insurance subscription status, related legal regulation information, and the like. For example, a storage temperature and an expiration date in the case of refrigerated food, a lot number and an expiration date in the case of pharmaceuticals, shock sensor data and an antistatic measure history in the case of precision equipment, and a legal compliance status and restriction information of a storage section in the case of dangerous goods are also management targets. For example, by automatically registering using a barcode or an RFID at the time of warehousing of a package and automatically recording similarly at the time of delivery, a real-time inventory status and location tracking of the package are realized. For example, prioritization of warehousing and delivery work and automatic assignment of a storage area are also performed according to the priority and delivery deadline of the package. For example, image data captured at the time of inspection of a package is analyzed by an AI, the presence or absence of damage or stain is automatically determined, and if there is an abnormality, an administrator is immediately notified. For example, a transfer history of a package is recorded in chronological order, and it is possible to track in detail which worker transferred the package using which equipment and via which route. Specifically, the package information management unit includes a multimodal recognition system integrating a computer vision model based on a convolutional neural network and an RFID stream processing engine in order to accurately track and evaluate a physical state of a package in a digital space. The package information management unit acquires, as input data, a three-channel RGB image tensor acquired from a high-resolution camera installed at an inspection gate, and a time-series array of tag IDs continuously read from an RFID reader. As a specific example of the input data, the package information management unit receives image data of a cardboard box of 1024 by 1024 pixels, and a hexadecimal tag ID array read 50 times per second. The computer vision model extracts a spatial feature map of an edge and a texture from an image using a plurality of convolutional layers and pooling layers. The computer vision model outputs, as an output, a continuous value score from zero to one indicating a damage probability of a package, and coordinate data of a bounding box indicating a damaged part. As a specific example of the output, the computer vision model outputs 0.95 as the damage probability, and outputs an array of XY coordinates indicating a dent in an upper right corner of the image. The package information management unit transmits these output results to a subsequent abnormality processing module. When the damage probability exceeds 0.8 which is a threshold value, the abnormality processing module immediately transmits a control command to discharge the package to a reject lane to a control device of a conveyor. With this configuration, the system eliminates a conventional inspection process that relied on visual inspection by a worker. The system determines a state of a package moving at high speed with high accuracy and instantaneously by fusing image analysis using deep learning and individual identification by radio waves. Thereby, the system eliminates a bottleneck of inspection work and dramatically improves a processing throughput of the entire logistics center. The present technology is extremely effective in a specific use case of a warehousing and shipping line for pharmaceuticals and precision equipment where strict quality control is required. The computer vision model is pre-trained to minimize a cross-entropy error using an image data set of past normal packages and damaged packages. The system applies random rotation, cropping, and brightness adjustment of an image as a data augmentation method, and enhances robustness of the model against a change in lighting conditions. For RFID read data, the system removes noise using a Kalman filter and estimates an accurate three-dimensional position of a package. Thereby, the system realizes complete synchronization between a physical world and a digital world.

The worker management unit manages in detail a worker ID, a name, a qualification (for example, a forklift driving qualification, a dangerous goods handling qualification, a health supervisor qualification, and the like), an assignable work type, a past work history, a mistake history, a skill evaluation, a work shift, a health condition, a work efficiency and safety index for each worker, vital data (heart rate, body temperature, number of steps, fatigue degree, and the like) acquired from a wearable device, an attendance record, an education attendance history, an award/disciplinary history, an accident/near-miss report history for each worker, a communication history between workers, a desired shift and leave application information of a worker, and the like. For example, automatic assignment is performed so that only a forklift qualification holder can take charge of package transfer in a specific area. For example, a high-risk work is not assigned to a worker who has made many mistakes in the past. For example, a health condition and a fatigue degree of a worker are acquired from a wearable device, and a break is recommended when an overwork risk is high. For example, a work efficiency and a safety index for each worker are quantitatively evaluated and utilized for optimization of an education plan and personnel assignment. For example, a communication history of a worker is analyzed to evaluate a teamwork issue and a leadership demonstration status. Specifically, the worker management unit includes a human resource management engine integrating a time-series analysis model based on a long short-term memory network and a mathematical optimization algorithm in order to achieve both ensuring worker safety and maximizing productivity. The worker management unit acquires, as input data, a time-series tensor of vital signs acquired from a wearable device worn by a worker, and a multidimensional feature vector indicating a skill level of each worker. As a specific example of the input data, the worker management unit receives a 60-row, 2-column numerical matrix in which a heart rate and an acceleration sensor value for the past one hour are recorded at one-minute intervals, and an integer value evaluating a forklift operation skill on a five-point scale. The time-series analysis model learns a temporal variation pattern of vital data using a long short-term memory network, and quantifies an accumulation degree of fatigue. The time-series analysis model outputs, as an output, a continuous value score from zero to one hundred indicating a fatigue degree of each worker, and a percentage value indicating a near-miss occurrence probability within the next one hour. As a specific example of the output, the time-series analysis model outputs 85 as the fatigue degree score, and outputs 70 percent as the near-miss occurrence probability. The worker management unit transmits these output results to a subsequent task assignment module. The task assignment module interrupts a currently active task for a worker whose fatigue degree score exceeds 80 which is a threshold value, and push-notifies a mandatory break instruction to a smartwatch. With this configuration, the system eliminates a conventional safety management method that relied on a patrol by an administrator or self-reporting. The system mathematically detects a sign of an accident by continuous monitoring of biological data and prediction based on deep learning. Thereby, the system dramatically reduces an occurrence rate of occupational accidents and realizes optimal personnel assignment according to a health condition of a worker. The present technology is extremely effective in a specific use case of work in a frozen warehouse under a severe temperature environment or picking work in a late-night time zone. The time-series analysis model is trained using a mean squared error function with a correlation between past vital data and an incident report as teacher data. In optimization of task assignment, the system uses mixed integer linear programming to solve an objective function that equalizes a load of each worker while minimizing an overall work delay. In order to protect personal privacy, the system adopts a federated learning method in which vital data is anonymized and then primary analysis is performed on an edge device side. Thereby, the system constructs an advanced prediction model while satisfying security requirements.

The equipment management unit manages in detail an equipment ID, an equipment type (for example, a transfer robot, an automatic sorting machine, a forklift, a refrigerator, a surveillance camera, a conveyor, a pallet rack, a security gate, a generator, an air conditioning equipment, and the like), an installation location, an operating time, a maintenance history, sensor data such as temperature, humidity, vibration, current value, and power consumption, a failure history, a replacement history of consumable parts, an operating efficiency and a failure rate for each equipment, an operating schedule of equipment, a use reservation status of equipment, a legal inspection history of equipment, a manufacturer, a model number, and a manufacturing date of equipment, a warranty period of equipment, an insurance subscription status of equipment, and the like. For example, an operating time and a remaining battery level of a transfer robot, a temperature fluctuation of a refrigerator, a vibration abnormality of a sorting machine, and the like are monitored in real time, and if there is an abnormal sign, an alert is immediately issued. For example, a timing of preventive maintenance and parts replacement is automatically proposed based on an operating status and a maintenance history of equipment. For example, an operating efficiency and a failure rate of equipment are analyzed and used as a judgment material for capital investment and layout change. For example, a work schedule and personnel assignment are optimized based on a use reservation status of equipment. Specifically, the equipment management unit accumulates sensor data as a multidimensional tensor using a time-series database. The system analyzes time-series data using a long short-term memory network or a transformer model equipped with a self-attention mechanism. Input data to the model is a multidimensional time-series array obtained by normalizing temperature, vibration, current value, and the like for a certain past period. As a specific example, the input data includes a battery voltage fluctuation vector of a transfer robot for the past 24 hours, a temperature transition array of a refrigerator every minute, a high-frequency vibration spectrum tensor of a sorting machine, and the like. The model extracts a latent feature amount from the input data. The model outputs an abnormality score indicating a degree of deviation from a data distribution in a normal state. As a specific example of output data, there are an abnormality probability value in a range of 0.0 to 1.0, a numerical vector indicating a remaining time until failure prediction, a classification label of an abnormality cause, and the like. When the output abnormality score exceeds a preset threshold value, the equipment management unit transmits an immediate alert to an administrator terminal as subsequent processing. The equipment management unit outputs a trigger signal for parts replacement to a preventive maintenance module. Thereby, the system prevents a sudden equipment stop. The system dramatically improves an equipment operating rate. The system exceeds a limit of visual inspection by a human and captures a minute abnormal sign in a high-dimensional space. The system brings about technical effects of reducing a maintenance cost and maximizing an operating efficiency in a use case such as a logistics center and a large-scale manufacturing plant.

The scheduling optimization unit comprehensively analyzes the package information, the worker information, and the equipment information accumulated in the package information management unit, the worker management unit, and the equipment management unit, and the traffic information and the weather information (for example, rainfall, snowfall, temperature, typhoon approach, road traffic jam, accident, road regulation, disaster information, and the like) acquired from the outside using a generative AI, and automatically determines an optimal worker assignment, work timing, and equipment utilization plan for each package in consideration of a type and priority of the package, a skill and qualification of the worker, an operating status and availability of the equipment, a traffic jam, a weather risk, and the like. For example, delivery work is preferentially assigned to a package whose delivery deadline is approaching or a high-priority package. For example, when a traffic jam is expected, a delivery time is moved forward, and when a typhoon approaches, an indoor storage area is preferentially assigned. For example, batch processing for efficiently carrying out a plurality of packages together can also be automatically planned. For example, an appropriate worker is assigned to transfer of a heavy object or dangerous goods based on a skill and qualification of a worker and a past work history. For example, a work plan is automatically adjusted in consideration of a use reservation status and a maintenance schedule of equipment. Specifically, the scheduling optimization unit adopts a hybrid AI architecture combining a graph neural network and a deep reinforcement learning model. Input data to the model is heterogeneous mixed data including an attribute vector of a package, a skill matrix of a worker, an operating state tensor of equipment, and a time-series array of an external environment. As a specific example, the input data includes a numerical vector indicating a delivery deadline and a weight of each package, a probability tensor indicating a past work completion time distribution of a worker, a scalar value indicating a predicted delay time of a traffic jam, and the like. The system maps these pieces of input data to a common latent space. The model searches for an optimal combination of each task and resource. Output data from the model is a binary matrix indicating assignment of a worker and equipment to each package, and a continuous value vector indicating a work start time. As a specific example of the output data, there are a list of optimal worker IDs for a specific high-priority package, a clustering label of a package group to be batch-processed, a timestamp array of scheduled start and end times of each work, and the like. The scheduling optimization unit transmits the output assignment matrix to an execution control module as subsequent processing. The execution control module push-notifies a specific work instruction to a mobile terminal of each worker. The system sets minimization of an overall work completion time and maximization of a resource operating rate as a reward function in deep reinforcement learning. The system eliminates a conventional scheduling method relying on human intuition. The system solves a high-dimensional constraint condition in real time. The system exhibits technical effects of preventing a work delay and dramatically improving a throughput in a use case such as a large-scale logistics base and a port container terminal.

The delivery route optimization unit automatically proposes a shortest and safe delivery route using a generative AI based on a delivery destination, a loading status of a delivery vehicle, traffic information, a past delay history, weather information, fuel consumption, mileage, and a maintenance status of a delivery vehicle, a skill and a working status of a delivery driver, an acceptable time zone of a delivery destination, a geographical condition of a delivery destination (for example, a slope, a narrow road, a snowy area, and the like), a loading restriction of a delivery vehicle, presence or absence of special equipment, and the like. For example, a route that avoids a road where a traffic jam or an accident has occurred and efficiently patrols a plurality of delivery destinations is recalculated in real time. For example, a shortest route is preferentially assigned to a refrigerated item or an urgent package. For example, in order to maximize loading efficiency of a delivery vehicle, loading of packages and a delivery order are automatically optimized. For example, a route with less risk is selected in consideration of weather and road regulation information. For example, a plan for time-specified delivery and night delivery is also automatically drafted in consideration of an acceptable time zone of a delivery destination. Specifically, the delivery route optimization unit includes a route search engine integrating a convolutional neural network that extracts a spatial feature and a regression model that predicts a time-series traffic fluctuation. Input data to the model is graph structure data representing a road network, a traffic volume tensor of each node, and a geographical coordinate vector of a delivery destination. As a specific example, the input data includes a numerical array indicating a real-time traffic jam length, a travel time probability distribution between nodes based on a past delay record, a scalar value indicating a current loaded weight and remaining fuel of a delivery vehicle, and the like. The system executes preprocessing of normalization and missing value completion on these pieces of input data. The model calculates an optimal patrol route using a reinforcement learning algorithm. Output data from the model is a permutation vector indicating a visit order, a numerical array indicating a predicted travel time of each section, and coordinate point cloud data of a recommended travel route. As a specific example of the output data, there are a list of optimized node IDs for patrolling 15 delivery destinations, a timestamp of each scheduled arrival time, polygon data indicating a traffic jam area to be avoided, and the like. The delivery route optimization unit transfers the output route data to a navigation module as subsequent processing. The navigation module displays turn-by-turn route guidance on an in-vehicle terminal of a delivery driver. The system executes recalculation of a route in real time when weather suddenly changes or a sudden accident occurs. The system derives an optimal solution under a dynamic and complex constraint condition that is difficult to handle by human rules of thumb. The system brings about clear technical effects of reducing fuel consumption, minimizing a delivery delay, and improving a vehicle operating rate in a use case such as last-mile delivery and wide-area trunk transportation.

The education plan proposal unit analyzes a skill evaluation for each worker, a past mistake history, a customer feedback content, a change in work content, an education attendance history, a hope and a career path of a worker, an accident/near-miss report occurred at a site, a health condition and vital data of a worker, newly introduced equipment and a new business process at a site, and the like, and automatically generates an individually optimized education and training plan using a generative AI. For example, “safe driving training” and “practical skill retraining” are proposed to a worker who makes many mistakes in forklift operation. For example, “customer response manner training” is recommended to a worker who has a low evaluation from a customer. For example, a basic work procedure and safety education are intensively assigned to a new worker. For example, when work content changes significantly, training for learning a new work procedure is automatically proposed. For example, when new equipment is introduced at a site, operation training for the corresponding equipment is automatically assigned to a target worker. For example, leadership training and training for managers are also automatically proposed according to a career path and a desired job type of a worker. Specifically, the education plan proposal unit implements a complex AI architecture combining a large language model responsible for natural language processing and a collaborative filtering algorithm constituting a recommendation system. Input data to the model is a time-series vector indicating an action history of a worker, a text embedding tensor of customer feedback, and a natural language vector of an accident report at a site. As a specific example, the input data includes a numerical array indicating the number of picking mistakes of a specific worker for the past one year, a 768-dimensional embedding representation obtained by vectorizing a complaint text from a customer, a feature amount vector extracted from an operation manual of newly introduced equipment, and the like. The system integrates these pieces of input data and quantifies a skill gap for each worker. Output data from the model is an ID list of recommended education contents, a score array indicating a priority of each training, and structured data of an individualized learning schedule. As a specific example of the output data, there are a recommendation score of 0.95 prompting attendance of safe driving training, a timestamp indicating a specific attendance date and time of customer response manner training, a link URL to a simulation program of new equipment operation, and the like. The education plan proposal unit transmits the output education plan to a learning management system as subsequent processing. The learning management system automatically distributes a training attendance instruction to a terminal of a target worker. In learning of the model, the system updates a weight using a work mistake reduction rate after attending training as a reward signal. The system eliminates uniform group training and provides adaptive learning perfectly suited to individual characteristics. The system realizes technical effects of improving a skill retention rate of a worker, dramatically reducing human errors, and optimizing an education cost in a use case such as a large-scale manufacturing industry and a logistics center.

The customer response proposal unit analyzes a content of customer feedback (for example, delivery delay, package damage, response quality, delivery mistake, packing defect, delivery slip entry mistake, inquiry response delay, complaint content, questionnaire result, evaluation on SNS, and the like) using a generative AI, and proposes a specific countermeasure such as “automatic generation of an apology letter”, “compensation proposal”, “explanation of a recurrence prevention measure”, “retraining proposal for a person in charge”, and “regular follow-up proposal to a customer” to a sales representative when there is a low evaluation or a complaint. For example, “apology for delivery delay and proposal of next discount coupon”, “compensation guidance at the time of package damage and explanation of recurrence prevention measure”, and the like are automatically generated. For example, when there is high-evaluation feedback from a customer, “automatic generation of a thank-you email”, “service proposal for an excellent customer”, and the like are also performed. For example, when a negative post on SNS is detected, a person in charge is immediately notified to prompt a quick response. For example, an inquiry content from a customer is analyzed, and an optimal answer draft is automatically extracted from an FAQ or a manual and presented to a person in charge. Specifically, the customer response proposal unit includes a transformer-based large language model and a classification neural network specialized for sentiment analysis. Input data to the model is an inquiry text from a customer, a character string of a call log converted from a voice recognition system, and structured data indicating a past transaction history. As a specific example, the input data includes a 500-character complaint text regarding a delivery delay, a multidimensional tensor obtained by vectorizing a negative post on SNS, a numerical vector indicating a past purchase amount and frequency of a customer, and the like. The system executes preprocessing of morphological analysis and stop word removal on the input text. The model determines an emotional polarity of a customer and an urgency of a request from the input data. Output data from the model is an emotion score, a classification category label, and text data of an automatically generated reply sentence. As a specific example of the output data, there are an emotion score of 0.88 indicating anger, a clustering label indicating a compensation request, a 300-character apology text including a fact that a next discount coupon is given, and the like. The customer response proposal unit transmits the output countermeasure to a sales support dashboard as subsequent processing. The dashboard pop-up displays a recommended action on a screen of a person in charge. The system automatically transmits an email to a customer when a person in charge presses an approval button. The system eliminates subjective and time-consuming sentence creation work by a human operator. The system extracts potential dissatisfaction of a customer with high accuracy using a natural language processing technology. The system brings about technical effects of dramatically shortening a response time, improving customer satisfaction, and preventing secondary flaming of a complaint in a use case such as a call center and customer support of e-commerce.

The trouble sign detection unit analyzes real-time equipment sensor data and worker flow line data acquired from the equipment management unit and the worker management unit, and a trouble history, a past accident pattern, environmental data such as temperature, humidity, noise, and illuminance at a site, an abnormal behavior pattern extracted from a surveillance camera video at a site, a vital data abnormality of a worker, a near-miss report at a site, life prediction data of a consumable part of equipment, and the like using a generative AI, and immediately issues an alert notification to an administrator terminal and automatically generates and presents a necessary countermeasure and a warning when detecting an abnormal temperature rise or abnormal vibration of equipment, a flow line pattern of a worker different from normal, a situation similar to a time of a past trouble occurrence, a rapid change in a site environment, a physical condition abnormality of a worker, a sign of end of life of a consumable part of equipment, or the like. For example, when a temperature of a transfer robot rises rapidly, or when a worker frequently moves on a route different from normal, an administrator is notified as an “equipment abnormality risk” or a “work procedure deviation risk”. For example, a past trouble pattern and current data are collated, and when a recurrence risk is high, an alert prompting an early response is issued. For example, when a life of a consumable part of equipment is approaching, a notification of “parts replacement recommendation” is automatically generated. For example, when illuminance or noise at a site exceeds a reference value, an alert is issued as a “work environment abnormality”. For example, when a heart rate or a body temperature of a worker shows an abnormal value, an administrator is notified as a “physical condition abnormality risk”. Specifically, the trouble sign detection unit adopts a multimodal AI architecture integrating a recurrent neural network that processes time-series data and a three-dimensional convolutional neural network that analyzes image data. Input data to the model is a high-frequency sensor data array from equipment, a continuous image tensor from a surveillance camera, and a time-series vector indicating vital data of a worker. As a specific example, the input data includes a 100-hertz vibration spectrum acquired from a motor of a transfer robot, a three-dimensional tensor indicating a transition of skeletal coordinates of a worker, a fluctuation array of a heart rate acquired from a smartwatch, and the like. The system synchronizes these heterogeneous data and projects them onto a common feature space. The model calculates a reconstruction error using an autoencoder learned from a data distribution in a normal state. Output data from the model is an abnormality probability score of each monitoring target, spatial coordinate data indicating an occurrence location of an abnormality, and a classification label indicating a type of a predicted trouble. As a specific example of the output data, there are a probability value of 0.92 indicating an equipment abnormality risk, a coordinate group of a bounding box indicating an abnormal behavior area in a surveillance camera video, a text label indicating a sign of end of life of a part, and the like. When the output abnormality score exceeds a specified threshold value, the trouble sign detection unit transmits a control signal to an emergency stop module as subsequent processing. The emergency stop module safely cuts off a power supply of the corresponding equipment. The system instantaneously identifies a minute environmental change or a complex abnormal sign that cannot be discovered by a human monitor. The system exhibits extremely important technical effects of preventing a serious accident, minimizing a downtime, and ensuring safety at a site in a use case such as a chemical plant and a large-scale automated warehouse.

In the present embodiment, each unit cooperates to optimize operation of the entire logistics center, and simultaneously realizes maximization of work efficiency, minimization of risk, improvement of customer satisfaction, ensuring of safety at a site, cost reduction, and reduction of a burden on a site administrator and a worker. For example, a generative AI performs advanced analysis, optimization, and automatic proposal in all business processes from warehousing of a package to delivery, delivery, customer response, equipment maintenance, education and training, and trouble prevention, and a system configuration is such that it can flexibly and in real time respond to a change in a situation at a site and a fluctuation in an external environment. For example, an AI automatically determines damage or stain at the time of warehousing of a package, and immediately notifies an administrator if there is an abnormality. For example, an AI constantly monitors a health condition and a fatigue degree of a worker, and automatically recommends a break when an overwork risk increases. For example, an AI analyzes sensor data of equipment, detects an abnormal sign or a sign of end of life of a consumable part at an early stage, and automatically generates a maintenance plan. For example, an AI analyzes a complaint or low-evaluation feedback from a customer, automatically generates an optimal apology letter, compensation plan, and recurrence prevention measure, and presents them to a person in charge. For example, an AI analyzes environmental data and a surveillance camera video at a site, immediately detects an abnormality in a work environment or an abnormal behavior of a worker, and issues an alert. For example, an AI optimizes a delivery route and a work schedule in real time, and flexibly responds to a traffic jam and a weather change. By integrally realizing these functions, the system comprehensively supports operating efficiency, safety, customer satisfaction, and sustainable growth of a site of a logistics center. Specifically, the system adopts a distributed microservice architecture in which each unit does not operate independently but synchronizes data in real time via a central integrated control server. The integrated control server includes a meta-learning model for integrating inference results output from each unit. Input data to the model is a multidimensional combined tensor indicating a status of the entire system, such as an inventory vector from the package information management unit, a task assignment matrix from the scheduling optimization unit, and an abnormality score array from the trouble sign detection unit. As a specific example, the input data includes a scalar value indicating a current total storage weight in the center, an average vital score indicating a fatigue degree of an operating worker, a percentage array indicating an operating rate of each equipment, and the like. The system processes these pieces of input data in real time and calculates an optimization index of the entire center. Output data from the model is a control vector instructing resource reallocation of the entire system, and a parameter adjustment signal for each unit. As a specific example of the output data, there are a control value instructing enhancement of an air conditioning output to a specific storage area, a schedule change flag for moving a break time forward, a boolean value triggering recalculation of a delivery route, and the like. The system feeds back the output control signal to each subsystem as subsequent processing. The system continuously updates a weight using reinforcement learning with maximization of an overall processing throughput and minimization of energy consumption as an objective function. The system autonomously searches for a global optimal solution without being limited to local optimization. The system brings about technical effects of dramatic reduction of an operation cost and extremely high self-healing capability against a fluctuation in an external environment in a use case such as a hub base of a huge supply chain.

### (System Configuration)

The system according to the present embodiment comprises a package information management unit, a worker management unit, an equipment management unit, a scheduling optimization unit, a delivery route optimization unit, an education plan proposal unit, a customer response proposal unit, and a trouble sign detection unit. The package information management unit registers, accumulates, and manages in detail a package ID, a package type, a weight, a size, a storage temperature condition, a scheduled warehousing date, a scheduled delivery date, a delivery destination, a priority, special handling information, a warehousing and delivery history, a past trouble history, barcode and RFID tag information, a packaging state, shipper information, delivery company information, photographic data of a package, storage area information, a conveyance history, an inspection result, a damage/stain record, an insurance subscription status, related legal regulation information, and the like for all packages carried into a logistics center, sets a storage temperature and an expiration date in the case of refrigerated food, a lot number and an expiration date in the case of pharmaceuticals, shock sensor data and an antistatic measure history in the case of precision equipment, a legal compliance status and restriction information of a storage section in the case of dangerous goods, and the like as management targets, automatically registers the package using a barcode or an RFID at the time of warehousing the package, realizes real-time inventory status and location tracking of the package by automatically recording the package similarly at the time of delivery, performs prioritization of warehousing and delivery work and automatic assignment of a storage area according to the priority and delivery deadline of the package, automatically determines the presence or absence of damage or stain by analyzing image data captured at the time of inspecting the package using a generative AI, immediately notifies an administrator if there is an abnormality, records the conveyance history of the package in chronological order, and can track in detail which worker conveyed the package using which equipment and through which route. Specifically, the package information management unit constructs a hybrid processing architecture in which an edge computing device and a cloud server are linked. The system implements an image recognition model based on a deep residual network in order to analyze the image data captured at the time of inspecting the package. Input data to the model is an RGB image tensor acquired from a high-resolution camera and point cloud data from a depth sensor. As a specific example, the input data includes an image matrix of 1024×1024 pixels indicating an appearance of a cardboard box, a 128-bit identification code acquired from an RFID reader, an acceleration vector for the past 24 hours recorded by a shock sensor, and the like. The system executes preprocessing of noise removal and contrast enhancement on the input image. The model extracts a feature map of an edge or a texture from the image through a convolutional layer. Output data from the model is a score indicating a damage probability of the package, a segmentation mask indicating a damaged part, and a classification category label of the package. As a specific example of the output data, there are a damage probability value of 0.85 indicating a dent in an outer box, a pixel coordinate group specifying an abnormal region in the image, a binary flag indicating a need for refrigeration, and the like. When the output damage probability exceeds a threshold value, the package information management unit transmits a reject signal to an automatic sorting machine as subsequent processing. The automatic sorting machine physically discharges the corresponding package to an inspection error area. The system completely eliminates an oversight caused by human visual inspection. The system instantaneously detects a minute stain or a packaging abnormality by pattern recognition in a high-dimensional image feature space. The system realizes technical effects of strict quality control and overwhelming speeding up of inspection work in use cases such as pharmaceutical logistics and precision equipment transportation.

The worker management unit manages in detail a worker ID, a name, a qualification, an assignable work type, a past work history, a mistake history, a skill evaluation, a work shift, a health condition, a work efficiency and safety index for each worker, vital data acquired from a wearable device, an attendance record, an education attendance history, an award/disciplinary history, an accident/near-miss report history for each worker, a communication history between workers, a desired shift and leave application information of a worker, and the like, automatically assigns, for example, only a forklift qualification holder to be in charge of package conveyance in a specific area, prevents a high-risk work from being assigned to a worker who has made many mistakes in the past, acquires the health condition and fatigue degree of the worker from the wearable device and recommends a break when an overwork risk is high, quantitatively evaluates the work efficiency and safety index for each worker and utilizes them for optimization of an education plan and personnel allocation, and analyzes the communication history of the worker to evaluate a teamwork issue and a leadership demonstration status. Specifically, the worker management unit includes a time-series analysis model combining a one-dimensional convolutional neural network and a long short-term memory network in order to process biometric data continuously streamed from the wearable device. Input data to the model is a multidimensional time-series vector acquired from a sensor worn by the worker. As a specific example, the input data includes a heart rate array sampled at one-second intervals, a motion waveform tensor from a three-axis acceleration sensor, continuous data of scalar values indicating fluctuations in skin temperature, and the like. The system applies a moving average filter to these pieces of input data and performs preprocessing to remove high-frequency noise. The model extracts a latent feature of the fatigue degree or stress level of the worker from the time-series data. Output data from the model is numerical data indicating a real-time fatigue degree score, a probability value of a decrease in concentration, and a recommended break time. As a specific example of the output data, there are a numerical value indicating that the fatigue degree score represented from 0 to 100 has reached 85, a probability value of 0.75 indicating that a fall risk is increasing, a time stamp instructing an immediate 15-minute break, and the like. When the output fatigue degree score exceeds a threshold value of a safety standard, the worker management unit transmits an alert signal to the scheduling optimization unit as subsequent processing. The scheduling optimization unit immediately reassigns a task of the corresponding worker to another standby personnel. The system eliminates conventional labor management depending on subjective observation by an administrator. The system scientifically captures a sign of overwork or an accident by objective and continuous analysis of the biometric data. The system brings about extremely important technical effects of preventing occupational accidents and maintaining labor productivity in use cases such as warehouse work under a harsh environment and a late-night shift.

The equipment management unit manages in detail an equipment ID, an equipment type, an installation location, an operating time, a maintenance history, sensor data such as temperature, humidity, vibration, current value, and power consumption, a failure history, a replacement history of consumable parts, an operating efficiency and failure rate for each equipment, an operating schedule of the equipment, a use reservation status of the equipment, a legal inspection history of the equipment, a manufacturer, model number, and manufacturing date of the equipment, a warranty period of the equipment, an insurance subscription status of the equipment, and the like, monitors, for example, an operating time and remaining battery level of a conveyance robot, a temperature fluctuation of a refrigerator, a vibration abnormality of a sorting machine, and the like in real time, immediately issues an alert if there is an abnormal sign, automatically proposes a timing of preventive maintenance and parts replacement based on the operating status and maintenance history of the equipment, analyzes the operating efficiency and failure rate of the equipment to use as a judgment material for capital investment and layout change, and optimizes a work schedule and personnel allocation based on the use reservation status of the equipment. Specifically, the equipment management unit adopts a federated learning architecture combining inference on an edge side and re-learning on a cloud side in order to process a huge amount of sensor data collected from a group of industrial Internet of Things devices in real time. The system implements an unsupervised learning model using a variational autoencoder and a generative adversarial network for abnormality detection of the equipment. Input data to the model is a multivariate time-series tensor from a sensor group attached to each equipment. As a specific example, the input data includes three-phase current waveform data of a conveyor motor, a frequency spectrum indicating a rotation speed of a cooling fan, a stress vector from a strain sensor of a pallet rack, and the like. The system applies a fast Fourier transform to the input data to perform conversion from a time domain to a frequency domain. The model learns a data distribution during normal operation, and calculates how much the input data deviates from the distribution. Output data from the model is an abnormality score based on a reconstruction error, a contribution vector of a sensor estimated to be a cause of the abnormality, and a continuous value indicating a predicted remaining life until failure. As a specific example of the output data, there are a score of 0.9 indicating an occurrence of an abnormality, a weight array indicating that vibration of a specific bearing is a main cause of the abnormality, numerical data indicating that 48 hours remain until failure, and the like. When the output predicted remaining life falls below a specified value, the equipment management unit transmits an API request to an automatic ordering system for maintenance parts as subsequent processing. The system eliminates regular calendar-based maintenance and completely realizes condition-based maintenance. The system exhibits technical effects of reducing downtime of the equipment to the utmost limit and optimizing a maintenance cost in use cases such as a large-scale manufacturing line and an automated logistics center.

The scheduling optimization unit comprehensively analyzes the package information, the worker information, and the equipment information accumulated in the package information management unit, the worker management unit, and the equipment management unit, and the traffic information and the weather information acquired from an outside using a generative AI, automatically determines an optimal worker assignment, work timing, and equipment utilization plan for each package in consideration of a type and priority of the package, a skill and qualification of the worker, an operating status and availability of the equipment, a traffic jam, a weather risk, and the like, automatically plans, for example, to preferentially assign delivery work to a package whose delivery deadline is approaching or a high-priority package, advance a delivery time when a traffic jam is expected, preferentially assign an indoor storage area when a typhoon is approaching, and automatically plan batch processing for efficiently carrying out a plurality of packages together, assigns an appropriate worker to conveyance of a heavy object or dangerous goods based on the skill and qualification of the worker and the past work history, and automatically adjusts a work plan in consideration of the use reservation status and maintenance schedule of the equipment. Specifically, the scheduling optimization unit includes an advanced calculation engine integrating a tensor network model simulating a quantum annealing algorithm and a deep reinforcement learning agent in order to solve a complex constraint satisfaction problem. Input data to the model is a huge state matrix expressing all resource states in a current center, and a context vector indicating a fluctuation of an external environment. As a specific example, the input data includes a multidimensional array indicating priorities and processing requirements of 5000 unprocessed packages, a matrix indicating current positions and skill levels of 100 workers, graph data indicating real-time traffic jam information of surrounding roads, and the like. The system formulates these pieces of input data as a state space in a Markov decision process. The model learns an optimal action-value function that maximizes a future cumulative reward using a policy gradient method. Output data from the model is an action matrix indicating allocation of all resources at each time step, and a probability distribution of a predicted task completion time. As a specific example of the output data, there are a binary flag assigning a worker A to picking work in an area B, a node sequence indicating a moving route of a specific conveyance robot, a score of 0.95 indicating a probability that the entire work is completed by a scheduled time, and the like. The scheduling optimization unit transmits the output action matrix to a programmable logic controller of each equipment and a terminal of the worker as subsequent processing. The system dynamically generates and updates a shift table and a work plan, which a human planner takes several hours to create, in milliseconds. The system brings about overwhelming technical effects of minimizing idle time of resources and maximizing throughput in use cases where a rapid fluctuation in demand or a sudden absence occurs.

The delivery route optimization unit automatically proposes a shortest and safe delivery route using a generative AI based on the delivery destination, a loading status of a delivery vehicle, traffic information, a past delay history, weather information, fuel consumption, mileage, and maintenance status of the delivery vehicle, a skill and working status of a delivery driver, an acceptable time zone of the delivery destination, a geographical condition of the delivery destination, a loading limit of the delivery vehicle, presence or absence of special equipment, and the like, recalculates, for example, a route that avoids a road where a traffic jam or an accident has occurred and efficiently patrols a plurality of delivery destinations in real time, preferentially assigns the shortest route to a refrigerated product or an urgent package, automatically optimizes loading of packages and a delivery order in order to maximize loading efficiency of the delivery vehicle, selects a low-risk route in consideration of weather and road regulation information, and automatically makes a plan for time-specified delivery and night delivery in consideration of the acceptable time zone of the delivery destination. Specifically, the delivery route optimization unit implements a reinforcement learning model combining a graph attention network and a deep Q-network in order to solve a dynamic traveling salesperson problem and a vehicle routing problem in real time. Input data to the model is directed graph data composed of delivery destination nodes and road edges, a dynamic state vector of each vehicle, and a time-series tensor of weather and traffic. As a specific example, the input data includes a matrix indicating latitude and longitude coordinates and specified time frames of 50 delivery destinations, scalar values indicating a current loading weight and remaining fuel of each truck, a time-series array indicating link travel times of major roads, and the like. The system calculates a distance matrix between nodes for the input data, and performs preprocessing to initialize a graph structure. The model searches for an optimal node visit order that minimizes total travel time and fuel consumption using a reinforcement learning agent. Output data from the model is a permutation vector of an optimized route for each vehicle, a predicted arrival time of each section, and polygon data for navigation. As a specific example of the output data, there are an index list indicating a visit order for a vehicle A, a time stamp indicating a scheduled arrival time at a next delivery destination, a coordinate point group of a detour route for avoiding a traffic jam, and the like. The system transmits the output route data to an in-vehicle terminal of each vehicle in real time as subsequent processing, and updates a navigation screen of the driver. The system eliminates a fixed delivery route and route selection depending on driver's intuition, and provides a mathematical optimal solution based on high-dimensional dynamic data. The system realizes clear technical effects of minimizing delivery delay, improving a vehicle operation rate, and reducing carbon dioxide emissions in use cases such as last-mile delivery and wide-area supply chain transportation.

The education plan proposal unit analyzes a skill evaluation for each worker, a past mistake history, a customer feedback content, a change in work content, an education attendance history, a hope and career path of the worker, an accident/near-miss report occurred at a site, a health condition and vital data of the worker, newly introduced equipment and a new business process at the site, and the like, automatically generates an individually optimized education and training plan using a generative AI, proposes, for example, safe driving training and practical retraining to a worker who makes many mistakes in forklift operation, recommends customer response manner training to a worker who has a low evaluation from a customer, intensively assigns a basic work procedure and safety education to a new worker, automatically proposes acquisition training of a new work procedure when the work content changes significantly, automatically assigns operation training of corresponding equipment to a target worker when new equipment is introduced at the site, and automatically proposes leadership training and training for managers according to the career path and desired occupation of the worker. Specifically, the education plan proposal unit adopts a deep learning architecture integrating a knowledge tracing model and a content-based recommendation algorithm in order to realize individual learning optimization. Input data to the model is a time-series vector indicating a past task execution log of the worker, a multidimensional tensor indicating a context at the time of mistake occurrence, and a feature amount matrix of available educational contents. As a specific example, the input data includes a numerical array indicating transitions of a picking speed and an error rate of a specific worker for the past three months, a scalar value indicating the number of sudden braking times during forklift operation, metadata indicating a difficulty level and required time of each training program, and the like. The system estimates a current potential skill level of the worker from the input data. The model predicts a skill improvement degree after taking a specific educational content using a recurrent neural network. Output data from the model is a ranking list of educational contents optimized for each worker, a predicted skill improvement score, and timeline data of a learning schedule. As a specific example of the output data, there are a recommendation list in which VR simulation training of a safety confirmation procedure is ranked first, a predicted value indicating that the error rate decreases by 20 percent after taking the course, a one-hour online learning schedule set on a next off-duty day, and the like. The education plan proposal unit transmits the output education plan to a personnel management system as subsequent processing, and automatically secures a reservation frame for training. The system eliminates uniform manual education and provides data-driven adaptive learning. The system brings about clear technical effects of shortening an education period, equalizing work quality, and preventing a serious accident in use cases such as a logistics site with a high turnover rate and a manufacturing industry where multi-skilling is required.

The customer response proposal unit analyzes the content of the customer feedback using a generative AI, proposes a specific countermeasure such as automatic generation of an apology letter, a compensation proposal, an explanation of a recurrence prevention measure, a re-education proposal for a person in charge, and a regular follow-up proposal to a customer to a sales representative when there is a low evaluation or a complaint based on delivery delay, package damage, response quality, delivery mistake, packaging defect, delivery slip entry mistake, delay in inquiry response, complaint content, questionnaire result, evaluation on SNS, and the like, automatically generates, for example, an apology for delivery delay and a proposal of a next discount coupon, or compensation guidance and an explanation of a recurrence prevention measure at the time of package damage, also performs automatic generation of a thank-you email and a service proposal for an excellent customer when there is high-evaluation feedback from the customer, immediately notifies the person in charge and prompts a prompt response when detecting a negative post on SNS, and analyzes an inquiry content from the customer to automatically extract an optimal answer draft from an FAQ or a manual and present it to the person in charge. Specifically, the customer response proposal unit includes a dedicated large language model obtained by fine-tuning a pre-trained transformer model responsible for natural language understanding and generation with data of a specific business domain. Input data to the model is a text message from the customer, a transcript of a voice call, and a structured vector indicating a past purchasing behavior of the customer. As a specific example, the input data includes a 400-character complaint sentence including anger regarding product damage, a scalar value indicating the number of past inquiries, numerical data indicating a lifetime value of the customer, and the like. The system executes preprocessing of tokenization and positional encoding on the input text. The model extracts an important keyword and a context dependency relationship in the text using a self-attention mechanism. Output data from the model is an emotion polarity score of the customer, an intent classification label of the inquiry, and a text token sequence of an automatically generated reply sentence. As a specific example of the output data, there are an emotion score of 0.95 indicating a negative degree, a clustering label indicating a product replacement request, a 500-character reply draft including a polite apology and a specific return procedure, and the like. The customer response proposal unit transfers the output reply draft to a user interface of a customer support system as subsequent processing, and adds it to a confirmation waiting queue of an operator. The system eliminates a conventional automatic response by a simple combination of fixed phrases, and performs advanced natural language generation perfectly adapted to the context. The system exhibits technical effects of dramatically shortening a response lead time, reducing a mental load on the operator, and lowering a customer defection rate in use cases such as a large-scale E-commerce platform and a global logistics service.

The trouble sign detection unit analyzes real-time equipment sensor data and worker flow line data acquired from the equipment management unit and the worker management unit, a trouble history and a past accident pattern, environmental data such as temperature, humidity, noise, and illuminance at a site, an abnormal behavior pattern extracted from a surveillance camera video at the site, a vital data abnormality of a worker, a near-miss report at the site, life prediction data of consumable parts of equipment, and the like using a generative AI, immediately issues an alert notification to an administrator terminal and automatically generates and presents a necessary countermeasure and a warning when detecting an abnormal temperature rise or abnormal vibration of the equipment, a flow line pattern of the worker different from normal, a situation similar to a time of a past trouble occurrence, a rapid change in a site environment, a physical condition abnormality of the worker, a sign of end of life of consumable parts of the equipment, or the like, notifies an administrator as an equipment abnormality risk or a work procedure deviation risk, for example, when the temperature of a conveyance robot rises rapidly or when the worker frequently moves on a route different from normal, collates the past trouble pattern and current data to issue an alert prompting early response when a recurrence risk is high, automatically generates a notification of parts replacement recommendation when the life of the consumable parts of the equipment is approaching, issues an alert as a work environment abnormality when the illuminance or noise at the site exceeds a reference value, and notifies the administrator as a physical condition abnormality risk when the heart rate or body temperature of the worker shows an abnormal value. Specifically, the trouble sign detection unit implements a deep learning model in which a three-dimensional convolutional neural network and a long short-term memory network are cascade-connected in order to simultaneously extract spatial and temporal abnormal patterns. Input data to the model is a synchronized video stream tensor from a plurality of surveillance cameras installed at the site, and a multivariate time-series array from an environmental sensor. As a specific example, the input data includes an RGB image sequence with a resolution of 1920×1080 acquired at 30 frames per second, a heat map matrix indicating a temperature distribution in a space, an acoustic feature amount vector indicating a fluctuation in noise level, and the like. The system calculates an optical flow from the input video stream, and performs preprocessing to extract a trajectory of a dynamic object. The model calculates a reconstruction error between the input data and a normal model using a latent space model that has learned a pattern of a normal work scene or equipment operation. Output data from the model is an abnormality probability score for each frame, a bounding box of spatial coordinates where an abnormality occurs, and a category label of a predicted trouble. As a specific example of the output data, there are an abnormality score of 0.98 indicating an initial sign of fire, a pixel coordinate group indicating a specific area at the upper right of a screen, a text label indicating a fall of a worker, and the like. When the output abnormality score exceeds a critical threshold value, the trouble sign detection unit automatically activates an alarm system of the entire building as subsequent processing, and simultaneously push-notifies a clip video of the site to a smartphone of the administrator. The system exceeds the limit of human visual monitoring, and detects a minute abnormality by integrating a plurality of sensor modalities. The system brings about extremely important technical effects of preventing a catastrophic accident and minimizing damage in use cases such as a dangerous goods handling facility and an unmanned warehouse operating 24 hours a day.

Specific examples of a prompt sentence to be read by the generative AI when implementing the present invention include “Please propose an optimal work assignment based on today's scheduled warehousing packages and a worker skill table”, “Please extract equipment requiring maintenance from operating times and sensor data of equipment”, “Please collate a past trouble history and current data and generate an alert if there is an abnormal sign”, “Please automatically generate an apology letter and a countermeasure for low-evaluation feedback from a customer”, “Please optimize today's delivery route in consideration of traffic jam information”, “Please create an individual education plan based on a mistake history and a skill evaluation for each worker”, “Please extract an abnormal behavior pattern from a surveillance camera video at a site and notify if there is a risk”, and the like. Specifically, the system includes a dynamic prompt generation module using prompt engineering technology in order to give a structured instruction to a large language model. Input data to the module is a real-time system state vector collected from each subsystem, a query in natural language from a user, and metadata indicating a constraint condition of a task. As a specific example, the input data includes a scalar value indicating the current number of unprocessed tasks, a text in JSON format indicating an operating history of a specific equipment ID, a character string of a system prompt defining an output format, and the like. The system combines these pieces of input data, and dynamically constructs a prompt character string with a context that is easy for the model to understand. The model executes inference based on the input prompt, and generates an optimal solution or text. Output data from the model is an executable code snippet, structured JSON data, or answer text in natural language. As a specific example of the output data, there are an SQL query for updating a shift table of a worker, a setting parameter group for adjusting a threshold value for abnormality detection, natural language text constituting an apology letter to a customer, and the like. The system passes the output data to a syntax analysis module as subsequent processing, and converts it into a command directly executable by the system. The system eliminates static rule-based command input, and realizes advanced system control through a natural language interface. The system exhibits technical effects of improving operational ease of the system and dramatically speeding up a decision-making process in a use case where even a site administrator without specialized programming knowledge can operate a complex AI system.

### (Implementation Steps)

### Step 1: Registration and Management of Package Information

For all packages carried into a logistics center, a package ID, a package type, a weight, a size, a storage temperature condition, a scheduled warehousing date, a scheduled delivery date, a delivery destination, a priority, special handling information, a warehousing and delivery history, barcode and RFID tag information, a packing state, shipper information, delivery company information, photographic data of the package, storage area information, a transport history, an inspection result, a damage and defacement record, an insurance subscription status, related legal regulation information, and the like are input from a terminal, and a package information management unit centrally accumulates and manages them on a server. For example, in the case of refrigerated food, a storage temperature and an expiration date, in the case of pharmaceuticals, a lot number and an expiration date, and in the case of precision equipment, impact sensor data and the like are also management targets. Specifically, in this step, the present system executes a distributed transaction process that optimizes data synchronization between an edge device and a cloud database. Input data to the present system is an image tensor from a multispectral camera installed at a carry-in gate, and a radio wave reception intensity vector from an RFID gateway. As a specific example, the input data includes a high-resolution image matrix simultaneously capturing a plurality of packages on a pallet, a numerical array of a unique identifier and a received signal intensity of an RFID tag attached to each package, and the like. The present system applies an object detection algorithm to an input image, and performs a preprocessing of extracting a bounding box of each individual package. The present system collates an extracted image feature with RFID data, and links a physical state and logical information of the package. Output data from the present system is a structured record of a normalized package attribute, and a commit log instructing writing to a database. As a specific example of the output data, there are a JSON object storing a package ID, a weight, a storage temperature condition, and the like, an insert statement for a specific table of the database, and the like. The present system asynchronously replicates an output record to a plurality of nodes of a distributed database as a subsequent process. The present system completely eliminates manual data input and individual barcode scanning work. The present system prevents data loss and inconsistency in an environment where a large amount of packages move at high speed. The present system brings about technical effects of improving throughput of warehousing processing and ensuring real-time accuracy of inventory data in a use case such as a large-scale cross-docking base.

### Step 2: Registration and Management of Worker and Equipment Information

A worker management unit manages worker information such as a worker ID, a name, a qualification, an assignable work type, a past work history, a mistake history, a skill evaluation, a work shift, a health condition, vital data, an education attendance history, an award and disciplinary history, an accident and near-miss report history, a desired shift and leave application information, and the like in detail, and an equipment management unit manages equipment information such as an equipment ID, an equipment type, an installation location, an operating time, a maintenance history, sensor data, a failure history, a replacement history of consumable parts, an operating efficiency and a failure rate, a use reservation status, a legal inspection history, a warranty period, an insurance subscription status, and the like in detail. Specifically, in this step, the present system constructs a real-time data pipeline combining an in-memory database and a stream processing engine in order to track dynamic state changes of a worker and equipment. Input data to the present system is a time-series stream of GPS coordinates and vital data transmitted from a smart device of the worker, and an operating status vector output from a programmable logic controller of the equipment. As a specific example, the input data includes latitude and longitude information of the worker updated every second, a numerical array indicating a heart rate and a body surface temperature, a scalar value indicating a current position and a remaining battery level of a transport robot, and the like. The present system executes a preprocessing of filtering an abnormal value and synchronizing a time stamp on these high-frequency input data. The present system calculates a moving average and a state transition event in real time using the stream processing engine. Output data from the present system is an updated state vector, and an event message notifying a state change. As a specific example of the output data, there are an updated score indicating a current fatigue level of the worker, a status flag indicating that the equipment has transitioned from a standby state to an operating state, an alert message detecting an entry into a specific area, and the like. The present system publishes an output event message to a message queuing system as a subsequent process so that another subsystem can immediately subscribe to it. The present system eliminates a delay due to batch processing, and maintains the latest state of all resources in the field with millisecond accuracy. The present system exhibits technical effects of improving responsiveness of the entire system and completely making resource management transparent in a use case such as an automated warehouse where dynamic task assignment and collision prevention control are required.

### Step 3: Scheduling Optimization

A scheduling optimization unit comprehensively analyzes package information, worker information, equipment information, traffic information, and weather information using a generative AI, and automatically determines an optimal worker assignment, work timing, and equipment utilization plan for each package in consideration of a type and priority of the package, a skill and qualification of a worker, an operating status and availability of equipment, a traffic jam, a weather risk, and the like. As a specific example of a prompt sentence to be read by the generative AI, “Please propose an optimal work assignment based on today's scheduled warehousing packages and a worker skill table”, “Please optimize today's work schedule in consideration of traffic jam information”, and the like are cited. Specifically, in this step, the present system drives an inference engine hybridizing an evolutionary algorithm and a deep neural network in order to solve a multi-objective optimization problem. Input data to the present model is a multidimensional tensor indicating the latest state of the package, the worker, and the equipment constructed in Step 1 and Step 2, and an environmental context vector acquired from an external API. As a specific example, the input data includes a matrix indicating a list of packages waiting for delivery and their deadlines, an array indicating a current fatigue level and position coordinates of each worker, graph data indicating real-time traffic jam information of surrounding roads, and the like. The present system integrates these pieces of input data, and generates a latent vector expressing a current system state. The present model evaluates schedule candidates that minimize an overall processing time in parallel while satisfying a plurality of constraint conditions. Output data from the present model is an optimized task assignment matrix, and timeline data indicating scheduled start and end times of each task. As a specific example of the output data, there are a binary matrix indicating a pair of a worker ID and a package ID, a node sequence indicating a movement route of each transport robot, a time stamp indicating a predicted completion time of the entire work, and the like. The present system transmits output schedule data to an execution management module as a subsequent process, and dispatches a specific work instruction to a device in the field. The present system eliminates static planning based on human rules of thumb, and dynamically and continuously recalculates a schedule in accordance with a change in a situation. The present system brings about extremely important technical effects of eliminating a bottleneck and maximizing overall throughput in a use case such as a peak time of demand or a time of sudden trouble occurrence.

### Step 4: Delivery Route Optimization

A delivery route optimization unit automatically proposes a shortest and safe delivery route using a generative AI based on a delivery destination, a loading status of a delivery vehicle, traffic information, a past delay history, weather information, a skill and work status of a delivery driver, an acceptable time zone, a geographical condition, and the like. As a specific example of a prompt sentence to be read by the generative AI, “Please propose today's optimal delivery route based on traffic jam information and a delivery destination list”, “Please plan a priority delivery route for refrigerated goods”, and the like are cited. Specifically, in this step, the present system executes a routing engine integrating a graph convolutional network and reinforcement learning in order to simultaneously process a dynamic traffic situation and a complex delivery constraint. Input data to the present model is a geographical coordinate vector of a delivery destination node group, a tensor indicating a loading state of each vehicle, and dynamic graph data including real-time traffic jam information. As a specific example, the input data includes a matrix indicating latitudes and longitudes and time-specified frames of 50 delivery destinations, a scalar value indicating a current loading weight and remaining fuel of each truck, a time-series array indicating a link travel time of a main road, and the like. The present system calculates a distance matrix between nodes for input data, and performs a preprocessing of initializing a graph structure. The present model searches for an optimal node visit order that minimizes a total travel time and fuel consumption using a reinforcement learning agent. Output data from the present model is a permutation vector of an optimized route for each vehicle, a predicted arrival time of each section, and polygon data for navigation. As a specific example of the output data, there are an index list indicating a visit order for a vehicle A, a time stamp indicating a scheduled arrival time at a next delivery destination, a coordinate point group of a detour route for avoiding a traffic jam, and the like. The present system transmits output route data to an in-vehicle terminal of each vehicle in real time as a subsequent process, and updates a navigation screen of a driver. The present system eliminates a fixed delivery route and route selection relying on intuition of a driver, and provides a mathematical optimal solution based on high-dimensional dynamic data. The present system realizes clear technical effects of minimizing a delivery delay, improving a vehicle operating rate, and reducing carbon dioxide emissions in a use case such as last-mile delivery or wide-area supply chain transportation.

### Step 5: Automatic Proposal of Education Plan

An education plan proposal unit analyzes a skill evaluation for each worker, a past mistake history, a customer feedback content, a change in work content, an education attendance history, a career path, an accident and near-miss report, a health condition, new equipment information in the field, and the like, and automatically generates an individually optimized education and training plan using a generative AI. As a specific example of a prompt sentence to be read by the generative AI, “Please create an individual education plan based on a mistake history and a skill evaluation for each worker”, “Please extract an operation training target person accompanying introduction of new equipment”, and the like are cited. Specifically, the education plan proposal unit converts attribute data and history data of a worker into a multidimensional numerical vector. The education plan proposal unit includes a transformer-based large language model specialized for a natural language processing task. The education plan proposal unit tokenizes text data as a preprocessing of input data. The education plan proposal unit maps tokenized data to an embedding vector space. The education plan proposal unit generates, for example, a 512-dimensional input tensor. Input data to the large language model includes a time-series array indicating a past mistake occurrence frequency of the worker. Input data to the large language model includes an emotion score of customer feedback. Input data to the large language model includes a text vector of an operation manual of new equipment. The large language model calculates a hidden correlation between each input element using a self-attention mechanism. The large language model executes a matrix operation in a high-dimensional space. The large language model outputs structured data including an identifier of a recommended education module as an output. The large language model outputs a probability distribution indicating a fitness of each education module. The large language model outputs, for example, 0.95 as a score recommending re-education of a safety confirmation procedure. The large language model outputs 0.88 as a recommended score for new equipment operation training. The education plan proposal unit executes a threshold determination on an output probability distribution. The education plan proposal unit extracts an education module exceeding a threshold. The education plan proposal unit transmits an extracted education module to a schedule management module. The schedule management module automatically reserves a training schedule by collating with a work shift of the worker. The present system plans an objective education plan that does not depend on subjectivity of an administrator by this processing. The present system reduces an accident occurrence rate caused by a lack of skill of the worker. The present system realizes delivery of optimal education contents while suppressing wasteful consumption of computer resources. The large language model is continuously fine-tuned using feedback data indicating a past education effect. The present system updates a weight of a neural network using an error backpropagation method. The present system executes learning so as to minimize a cross-entropy error function. As a specific application field of the present technology, worker education in a production line of a manufacturing plant is cited. As a specific application field of the present technology, safety and health education at a construction site is cited.

### Step 6: Automatic Proposal of Customer Countermeasure

A customer response proposal unit analyzes customer feedback, a complaint, a questionnaire result, an evaluation on SNS, an inquiry content, and the like using a generative AI, and automatically generates a specific countermeasure such as automatic generation of an apology letter, a compensation proposal, an explanation of a recurrence prevention measure, a re-education proposal for a person in charge, and a follow-up proposal to a customer when there is a low evaluation or a complaint. As a specific example of a prompt sentence to be read by the generative AI, “Please automatically generate an apology letter and a countermeasure for low evaluation feedback from a customer”, “Please propose a countermeasure plan for a negative post on SNS”, and the like are cited. Specifically, the customer response proposal unit continuously collects unstructured text data via an external interface. The customer response proposal unit inputs collected text data to a natural language processing engine. The natural language processing engine includes a hybrid model combining a recurrent neural network and a transformer architecture. The customer response proposal unit executes a preprocessing of removing noise from an input text. The customer response proposal unit converts a preprocessed text into a word embedding vector. Input data to the hybrid model includes a text tensor indicating a complaint content of the customer. Input data to the hybrid model includes a numerical vector indicating a past purchase history of the customer. Input data to the hybrid model includes time-series data indicating a posting date and time on social media. The hybrid model applies a multi-layer self-attention calculation to an input vector. The hybrid model determines an emotion polarity in a text. The hybrid model outputs a classification label indicating a category of a countermeasure as an output. The hybrid model outputs a text sequence of a generated apology letter. The hybrid model outputs numerical data indicating a recommended value of a compensation amount. The hybrid model outputs, for example, 0.92 as a probability score proposing product replacement. The hybrid model outputs 0.85 as a probability score issuing a next discount coupon. The customer response proposal unit inputs an output text sequence to a syntax analysis module. The syntax analysis module verifies grammatical accuracy of a generated sentence. The customer response proposal unit transfers verified countermeasure data to an automatic mail transmission module. The automatic mail transmission module immediately transmits a message to contact information of the customer. The present system completes an initial response in milliseconds without intervention of a human operator by this series of processing. The present system reduces a risk that dissatisfaction of the customer spreads on social media. The present system prevents damage to brand value due to a delay in response. The hybrid model is constructed by supervised learning using a past successful response case as correct answer data. The present system optimizes a parameter of a model using a gradient descent method. As a specific application field of the present technology, a customer support business in an electronic commerce platform is cited. As a specific application field of the present technology, automation of a call center business of a telecommunications carrier is cited.

### Step 7: Trouble Sign Detection and Alert Transmission

A trouble sign detection unit analyzes equipment sensor data, worker flow line data, a trouble history, an accident pattern, environmental data of a field, a surveillance camera video, vital data of a worker, consumable part life prediction data, and the like using a generative AI, and immediately issues an alert notification to an administrator terminal and automatically generates and presents a necessary countermeasure and a warning when detecting an abnormal temperature rise or abnormal vibration of equipment, a flow line pattern of the worker different from normal, a situation similar to a time of a past trouble occurrence, a rapid change in a field environment, a physical condition abnormality of the worker, a sign of end of life of a consumable part of the equipment, or the like. As a specific example of a prompt sentence to be read by the generative AI, “Please collate a past trouble history and current status data and generate an alert if there is an abnormal sign”, “Please detect an abnormal sign from sensor data of equipment”, and the like are cited. Specifically, the trouble sign detection unit receives streaming data in real time from a plurality of IoT devices installed in the field. The trouble sign detection unit includes a multimodal neural network that integrally processes received heterogeneous data. The trouble sign detection unit inputs time-series sensor data to a one-dimensional convolutional neural network. The trouble sign detection unit inputs a video frame of a surveillance camera to a three-dimensional convolutional neural network. Input data to the multimodal neural network includes a time-series array indicating a temperature transition of the equipment. Input data to the multimodal neural network includes a numerical vector of vital data indicating a heart rate of the worker. Input data to the multimodal neural network includes a spatial coordinate tensor indicating a movement trajectory of the worker. The multimodal neural network integrates a feature amount vector extracted from each modality in a connection layer. The multimodal neural network executes an anomaly detection algorithm in an integrated high-dimensional feature space. The multimodal neural network outputs a continuous value score indicating a failure probability of each equipment as an output. The multimodal neural network outputs a classification label indicating a type of anomaly. The multimodal neural network outputs, for example, 0.89 as a probability of abnormal vibration due to bearing wear of a motor. The multimodal neural network outputs 0.95 as a heatstroke risk score of the worker. The trouble sign detection unit determines whether or not an output probability score exceeds a preset safety threshold. The trouble sign detection unit immediately generates an interrupt process when detecting that the threshold is exceeded. The trouble sign detection unit activates a generative AI module to generate a specific avoidance procedure text. The trouble sign detection unit push-notifies a generated text and a warning flag to the administrator terminal. The present system realizes preventive maintenance activity instead of post-response by this processing. The present system minimizes downtime of a production line due to a sudden stop of the equipment. The present system eliminates a delay in data processing, and enables high-speed inference in an edge computing environment. The multimodal neural network calculates an anomaly degree using unsupervised learning by an autoencoder using data at a normal time. As a specific application field of the present technology, an equipment monitoring system in a large-scale chemical plant is cited. As a specific application field of the present technology, a safety management system for a worker at a construction site is cited.

### (Specific Use Case)

For example, a situation is assumed in which a wide variety of packages such as a large amount of refrigerated food, precision equipment, dangerous goods, and general merchandise are simultaneously warehoused in a logistics center. A package information management unit registers a package ID, a package type, a weight, a size, a storage temperature condition, a scheduled warehousing date, a scheduled delivery date, a delivery destination, a priority, special handling information, image data at a time of inspection, a damage and defacement record, an insurance subscription status, and the like in detail for each package using a barcode or an RFID tag, and also sets a storage temperature and an expiration date for refrigerated food, impact sensor data and an antistatic measure history for precision equipment, and a legal compliance status and restriction information of a storage section for dangerous goods as management targets. A worker management unit manages a forklift driving qualification, a dangerous goods handling qualification, a past work history, a mistake history, a skill evaluation, a work shift, a health condition, vital data, an education attendance history, and the like for each worker, and an equipment management unit manages an equipment ID, an operating time, a maintenance history, sensor data, a failure history, a replacement history of consumable parts, and the like of a transport robot, an automatic sorting machine, a refrigerator, a surveillance camera, a conveyor, and the like in detail. Specifically, the present system constructs a digital twin platform that reproduces a complex dynamic environment of the logistics center in a digital space. The package information management unit analyzes radio wave signal intensity data transmitted at high frequency from an RFID reader. The package information management unit estimates three-dimensional position coordinates of the package in real time using a Kalman filter. The package information management unit stores acquired package attribute data in a normalized table group of a relational database. The package information management unit inputs high-resolution image data acquired from an inspection camera to a convolutional neural network. Input data to the convolutional neural network includes an RGB image tensor of 1024 pixels square. Input data to the convolutional neural network includes a two-dimensional array including depth information of an outer box of the package. The convolutional neural network detects a minute scratch or dent in an image. The convolutional neural network outputs a binary label indicating presence or absence of damage as an output. The convolutional neural network outputs bounding box coordinates of a damaged part. The convolutional neural network outputs, for example, 0.98 as a probability score indicating crushing of a corner of a cardboard. The worker management unit collects time-series data of a heart rate and a body surface temperature transmitted from a wearable device. The worker management unit inputs collected vital data to a long short-term memory network to calculate a fatigue score. The equipment management unit converts a motor current value and vibration frequency data of the transport robot into a frequency domain. The equipment management unit extracts a feature amount using a fast Fourier transform. The present system accumulates these enormous heterogeneous data in an integrated data lake. The present system generates a multidimensional vector of a unified format that can be referred to by a subsequent optimization algorithm. The present system prevents information silos by this data integration processing. The present system reduces data communication overhead between each subsystem. The present system visualizes an operating status of a physical logistics resource with millisecond accuracy. As a specific application field of the present technology, an automatic sorting system for air cargo at an international hub airport is cited. As a specific application field of the present technology, integrated management of a huge fulfillment center for electronic commerce is cited.

The scheduling optimization unit comprehensively analyzes the priority of the package, the delivery deadline, the skill and qualification of the worker, the operating status of the equipment, the traffic information, and the weather information using a generative AI, and by giving a prompt such as “Please propose an optimal work assignment based on today's scheduled warehousing packages and the worker skill table”, for example, automatically assigns refrigerated food to a qualified worker in charge of a refrigerated area, hazardous materials to a hazardous material qualified person, and heavy items to a worker with a high physical strength evaluation, and simultaneously optimizes a utilization plan of a transport robot and a sorting machine. When a traffic jam or bad weather is expected, the scheduling optimization unit automatically adjusts a delivery time and a work order to minimize a delivery delay risk. Specifically, the scheduling optimization unit includes a deep reinforcement learning model for solving a constrained optimization problem. The scheduling optimization unit defines a state space in the logistics center based on a Markov decision process. Input data to the deep reinforcement learning model includes a numerical vector indicating a remaining time until the delivery deadline of each package. The input data to the deep reinforcement learning model includes matrix data indicating a current position and a skill level of the worker. The input data to the deep reinforcement learning model includes a time-series array of a precipitation probability and a traffic jam length acquired from an external API. The deep reinforcement learning model adopts an actor-critic architecture. The deep reinforcement learning model calculates an optimal action value from a representation of the state space. The deep reinforcement learning model outputs a task assignment matrix for each worker as an output. The deep reinforcement learning model outputs a node sequence indicating a routing path of the transport robot. The deep reinforcement learning model outputs, for example, a command instructing worker A to perform picking work in a hazardous material area. The deep reinforcement learning model outputs a control signal instructing transport robot B to move to the refrigerated area. The scheduling optimization unit converts the output assignment matrix into a control protocol of each device. The scheduling optimization unit transmits the converted control signal to a terminal of each worker and the transport robot via a wireless communication network. The system recalculates the schedule in real time in accordance with a dynamic change in an environment. The system completely eliminates manual assignment work by a human dispatcher. The system minimizes a waiting time of the worker and dramatically improves a processing throughput of the entire facility. The deep reinforcement learning model is trained to maximize a reward function through millions of trials and errors in a simulation environment. The system updates a weight in a direction of minimizing a delay penalty and energy consumption. A specific application field of the present technology includes automatic scheduling of container handling work at a port terminal. A specific application field of the present technology includes just-in-time delivery management of parts supply in a large-scale manufacturing plant.

The delivery route optimization unit analyzes a delivery destination list, a loading status of a delivery vehicle, traffic information, a past delay history, weather information, a skill and working status of a delivery driver, an acceptable time zone of a delivery destination, and the like using a generative AI, and by giving a prompt such as “Please propose today's optimal delivery route based on the traffic jam information and the delivery destination list”, preferentially delivers refrigerated goods through a shortest route, recalculates a route efficiently patrolling a plurality of delivery destinations in real time, and also optimizes loading efficiency and a delivery order. Specifically, the delivery route optimization unit includes a graph neural network for solving a traveling salesperson problem and a vehicle routing problem. The delivery route optimization unit models a road network as a directed graph composed of nodes and edges. Input data to the graph neural network includes a two-dimensional tensor indicating geographical coordinates of each delivery destination. The input data to the graph neural network includes a numerical vector indicating a real-time average vehicle speed of each road segment. The input data to the graph neural network includes an array of scalar values indicating a ratio of a current loaded weight to a maximum capacity of each vehicle. The graph neural network aggregates information between adjacent nodes using a message passing algorithm. The graph neural network extracts a topological feature of the entire graph. The graph neural network outputs a permutation vector indicating an optimal order of nodes to be visited by each vehicle as an output. The graph neural network outputs time-series data indicating an estimated arrival time at each delivery destination. The graph neural network outputs, for example, route data instructing vehicle C on a detour route from node 1 to node 5. The graph neural network outputs 0.99 as a probability score for completing the delivery within a temperature maintenance limit time of the refrigerated goods. The delivery route optimization unit converts the output route data into a GPS coordinate sequence for a navigation system. The delivery route optimization unit distributes the converted data to an in-vehicle terminal of each delivery vehicle in real time. The system recalculates an alternative route in milliseconds when detecting a sudden occurrence of a traffic jam. The system reduces fuel consumption of the vehicle and minimizes carbon dioxide emissions. The system mathematically minimizes a risk of penalty occurrence due to a delivery delay. The graph neural network optimizes a weight of an edge by supervised learning using a vast amount of past driving history data. A specific application field of the present technology includes dynamic routing of last-mile delivery in an urban area. A specific application field of the present technology includes a dispatch planning system for long-distance truck transportation covering a wide area.

The education plan proposal unit analyzes a mistake history and a skill evaluation for each worker, customer feedback, an accident/near-miss report, a health condition, new equipment information in a field, and the like using a generative AI, and by giving a prompt such as “Please create an individual education plan based on the mistake history and the skill evaluation for each worker”, automatically assigns safe driving training to a worker who makes many mistakes in forklift operation, customer response manner training to a worker with a low customer evaluation, and basic work procedures and safety education to a new worker. Specifically, the education plan proposal unit includes a deep learning-based recommendation system that integrates multifaceted evaluation data of the worker and quantifies a potential skill gap. The education plan proposal unit executes a hybrid recommendation algorithm combining collaborative filtering and content-based filtering. Input data to the recommendation system includes a one-hot vector of categorical data indicating a past mistake occurrence location of the worker. The input data to the recommendation system includes a multidimensional vector embedding a natural language text of the near-miss report. The input data to the recommendation system includes a normalized numerical array indicating an age and years of experience of the worker. The recommendation system learns a non-linear interaction between input vectors using a multilayer perceptron. The recommendation system calculates an inner product of a feature space of the worker and a feature space of the educational content. The recommendation system outputs a ranking list of a fitness score for each educational content as an output. The recommendation system outputs numerical data indicating an estimated learning time required to complete the course. The recommendation system outputs, for example, 0.94 as a recommendation score for VR simulation training regarding a turning operation of a forklift. The recommendation system outputs 0.87 as a recommendation score for complaint response role-playing training. The education plan proposal unit extracts top contents of the output ranking list. The education plan proposal unit automatically transmits a URI of the extracted content to a personal terminal of the worker. The system abolishes uniform group training and provides adaptive learning specialized for individual weaknesses. The system improves a compliance rate with safety standards in the field while reducing a time cost required for education. The system eliminates a cognitive bias when a human administrator manually formulates an education plan. The recommendation system continuously improves recommendation accuracy by reinforcement learning using a test score after taking the course and a mistake reduction rate as a reward signal. A specific application field of the present technology includes a skill-up support system for nurses in a medical institution. A specific application field of the present technology includes an automatic training system for part-time employees in a retail business developing multiple stores.

The customer response proposal unit analyzes feedback and a complaint from a customer, a questionnaire result, an evaluation on SNS, and an inquiry content using a generative AI, and by giving a prompt such as “Please automatically generate an apology letter and a countermeasure for low-evaluation feedback from a customer”, automatically generates an apology letter and a proposal of a next discount coupon for a delivery delay, a compensation guide and an explanation of a recurrence prevention measure for package damage, and a prompt response plan for a negative post on SNS, and presents them to a person in charge. Specifically, the customer response proposal unit includes a processing pipeline integrating a large language model optimized for a natural language generation task and a rule-based expert system. The customer response proposal unit specifies a customer name and an order number from the input text data using a named entity recognition algorithm. Input data to the large language model includes a text sequence describing a content of the customer's complaint. The input data to the large language model includes time-series data indicating a delivery status history of the corresponding order. The input data to the large language model includes context data obtained by vectorizing an official response guideline of a company. The large language model autoregressively generates a natural response text in accordance with a context using a decoder block of a transformer. The large language model outputs character string data of a draft sentence to be transmitted to the customer as an output. The large language model outputs an integer value score from 1 to 10 indicating an urgency of the response. The large language model outputs, for example, a text including an apology for the delivery delay and a code for a 20% discount coupon. The large language model outputs a text including an issuance link of a return label for the package damage. The customer response proposal unit inputs the output draft sentence to the expert system. The expert system verifies whether a legal risk word is included by regular expression matching. The customer response proposal unit records countermeasure data that has passed the verification in a customer management database. The customer response proposal unit displays a pop-up notification on a dashboard screen of the person in charge. The system shortens a lead time from occurrence of a complaint to presentation of an initial response plan to a few seconds. The system reduces a mental load on the person in charge and realizes uniform response quality. The system reduces a customer churn rate at a statistically significant level. The large language model is fine-tuned using a response history of an excellent customer support representative in the past. A specific application field of the present technology includes a real-time request response system from a guest in the hospitality industry. A specific application field of the present technology includes automation of a technical support desk for a software service.

The trouble sign detection unit analyzes equipment sensor data, worker flow line data, a trouble history, an accident pattern, environmental data of a field, a surveillance camera video, vital data of a worker, consumable part life prediction data, and the like using a generative AI, and by giving a prompt such as “Please collate the past trouble history with current data and generate an alert if there is an abnormal sign”, immediately detects a temperature rise and abnormal vibration of a transport robot, an abnormal flow line of the worker, a rapid change in a field environment, a sign of consumable part life expiration, a physical condition abnormality of the worker, and the like, issues an alert notification to an administrator terminal, and automatically generates and presents a necessary countermeasure and a warning. Specifically, the trouble sign detection unit includes a distributed machine learning architecture combining a feature amount primarily processed on an edge device side and advanced inference on a cloud side. The trouble sign detection unit executes an autoencoder network specialized for anomaly detection of time-series data. Input data to the autoencoder network includes a numerical tensor of a three-axis acceleration sensor acquired from each joint motor of the transport robot. The input data to the autoencoder network includes a time-series array of a skin temperature and a pulse acquired from a smartwatch of the worker. The input data to the autoencoder network includes a vector of environmental data acquired from a temperature and humidity sensor in a factory. The autoencoder network compresses the input data into a low-dimensional latent space. The autoencoder network reconstructs original data from the latent space. The autoencoder network outputs a continuous-value anomaly score indicating a reconstruction error between the input data and the reconstructed data as an output. The autoencoder network outputs an identifier of a sensor estimated to be a cause of the anomaly. The autoencoder network outputs, for example, 0.91 exceeding a threshold as an anomaly score of a drive motor of a conveyor belt. The autoencoder network outputs 0.85 as a score indicating an abnormal staying time of the worker. The trouble sign detection unit calls a large language model when the output anomaly score exceeds a specified value. The large language model receives the anomaly score and a past maintenance record as an input. The large language model generates text data indicating a specific inspection procedure. The trouble sign detection unit transmits the generated text data and an emergency stop command to a control system. The system mathematically captures a sign of a minute change that a human cannot notice. The system prevents a serious occupational accident and large-scale damage to the equipment. The system reduces unnecessary periodic maintenance and enables a transition to condition-based maintenance. The autoencoder network is constructed by unsupervised learning using only data during normal operation. A specific application field of the present technology includes an abnormality monitoring system for a reactor cooling system in a nuclear power plant. A specific application field of the present technology includes a predictive maintenance system for a vehicle state in fleet management of autonomous vehicles.

As described above, the system of the present invention realizes advanced analysis, optimization, and automatic proposal utilizing a generative AI in all business processes of package management, worker placement, equipment operation, work schedule, delivery plan, education and training, customer response, and trouble prevention in a field of a logistics center, and can comprehensively support efficiency improvement in the field, risk reduction, customer satisfaction improvement, safety securing, cost reduction, and burden reduction on a field administrator and a worker. Specifically, the system includes an orchestration engine that integrally controls a plurality of independent neural network modules. The orchestration engine asynchronously processes a vast data stream generated from each business process via a central message broker. Input data to the orchestration engine includes a tensor group of inference results output from each subsystem. The input data to the orchestration engine includes a vector of system metrics indicating a resource usage rate of the entire system. The input data to the orchestration engine includes a time-series array of a macroeconomic indicator and meteorological data indicating a change in an external environment. The orchestration engine searches for a global optimal solution of the entire system using a reinforcement learning algorithm. The orchestration engine outputs a control matrix indicating a dynamic allocation ratio of computing resources to each subsystem as an output. The orchestration engine outputs a predicted value of a performance indicator of the entire system. The orchestration engine outputs, for example, a control signal for increasing GPU resource allocation to a trouble sign detection module by 30%. The orchestration engine outputs numerical data of 100,000 cases as a predicted value of logistics throughput on the next day. The system automatically scales the number of replicas of a containerized application based on the output control matrix. The system achieves comprehensive optimization of the entire facility instead of local optimization by this autonomous feedback loop. The system solves a complex multivariable optimization problem exceeding a cognitive limit of a human administrator in real time. The system maximizes utilization efficiency of hardware resources and dramatically reduces an operation cost of cloud computing. The system adopts a federated learning method that links learning processes of respective modules. The system improves generalization performance of a model while protecting data privacy. A specific application field of the present technology includes an integrated management platform for urban infrastructure in a smart city. A specific application field of the present technology includes an enterprise resource planning system that optimizes an entire global supply chain.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

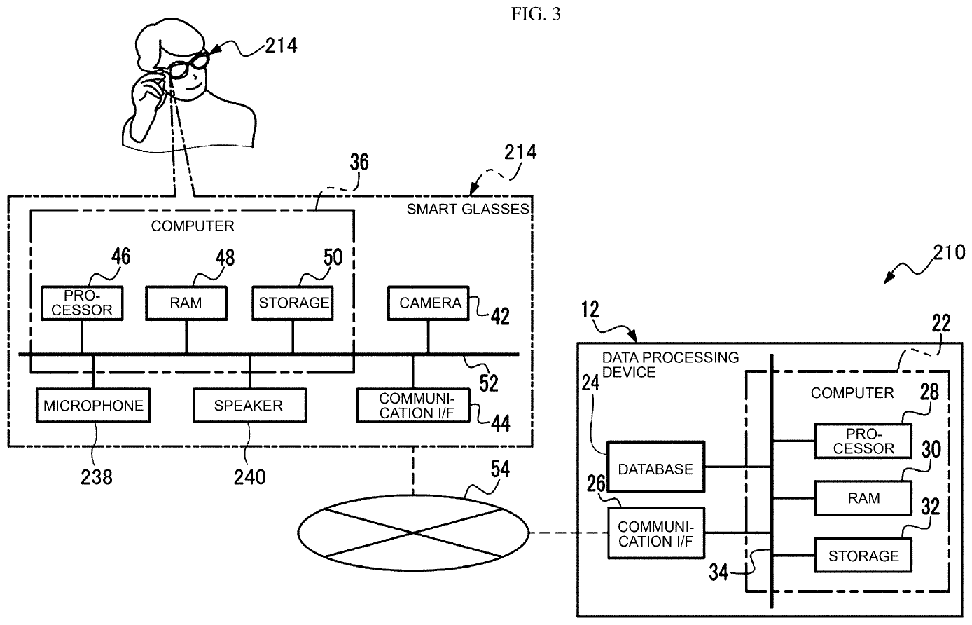

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

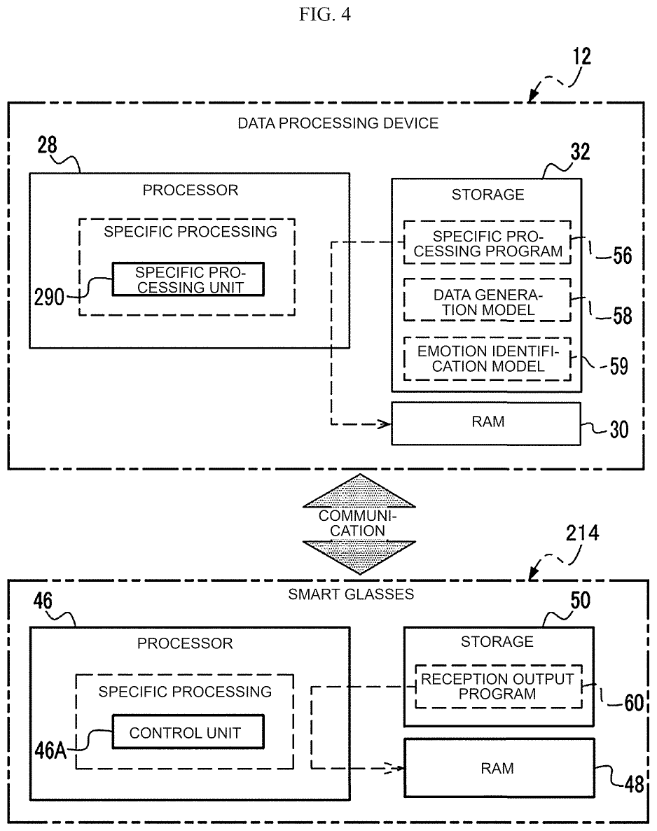

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### (Example 1)

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

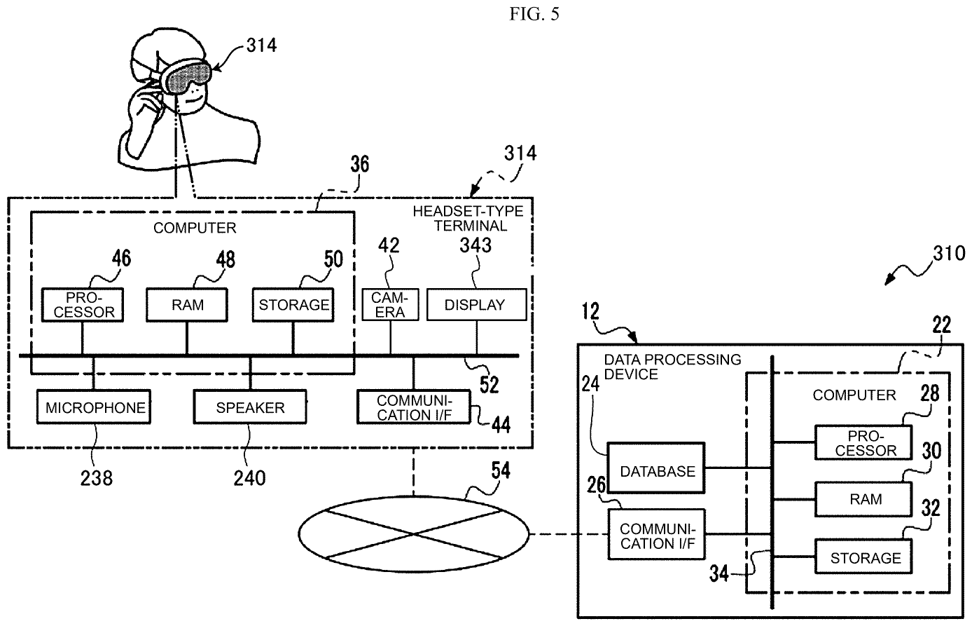

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

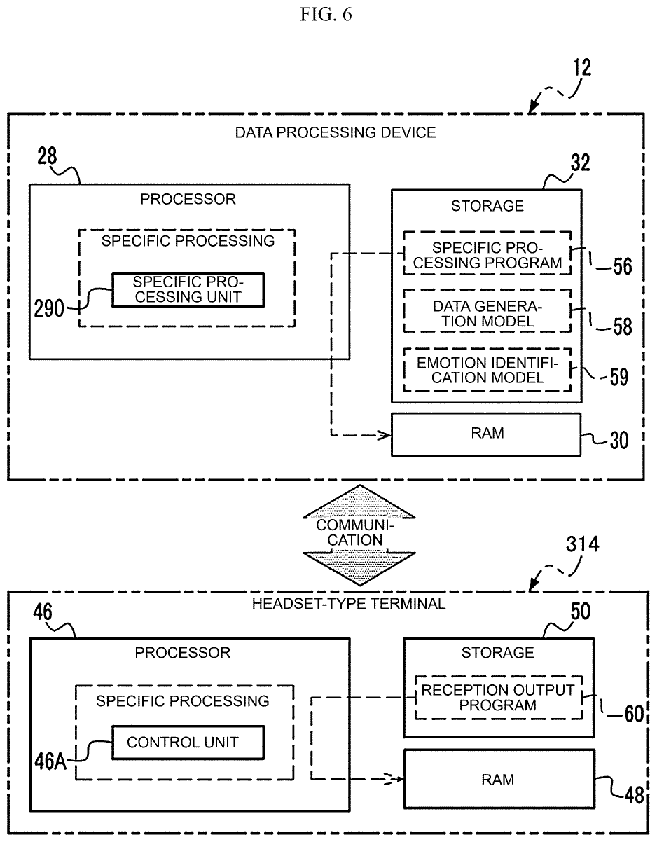

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

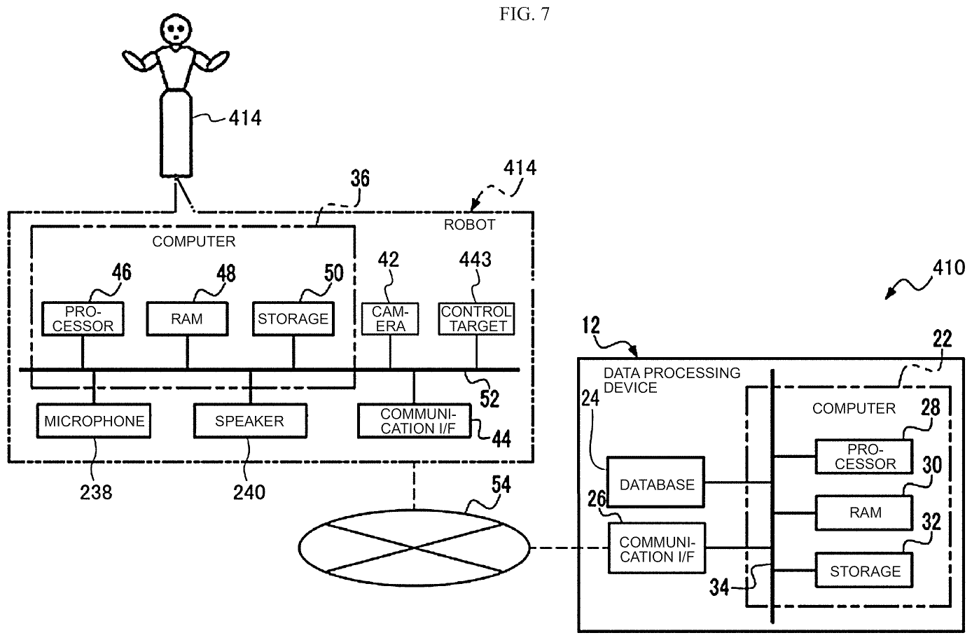

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

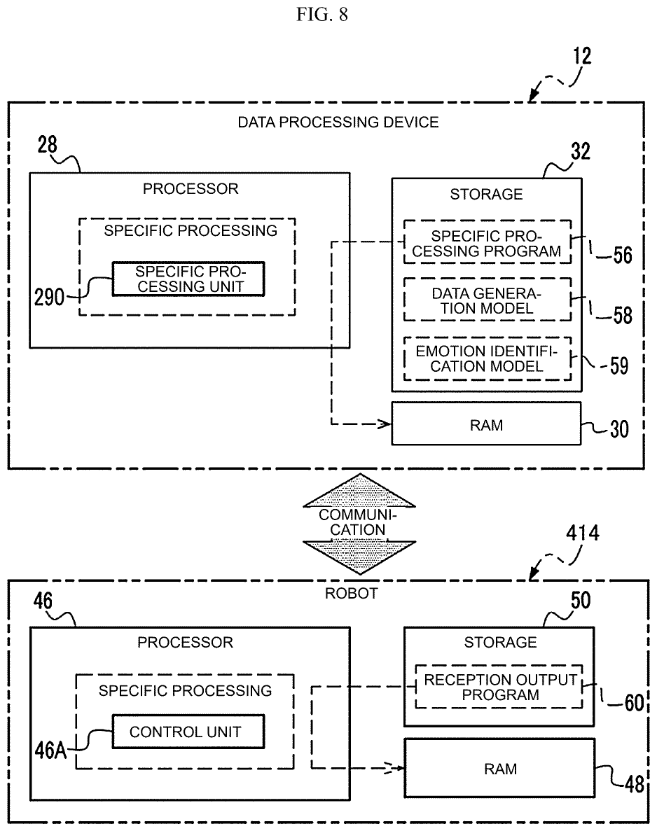

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

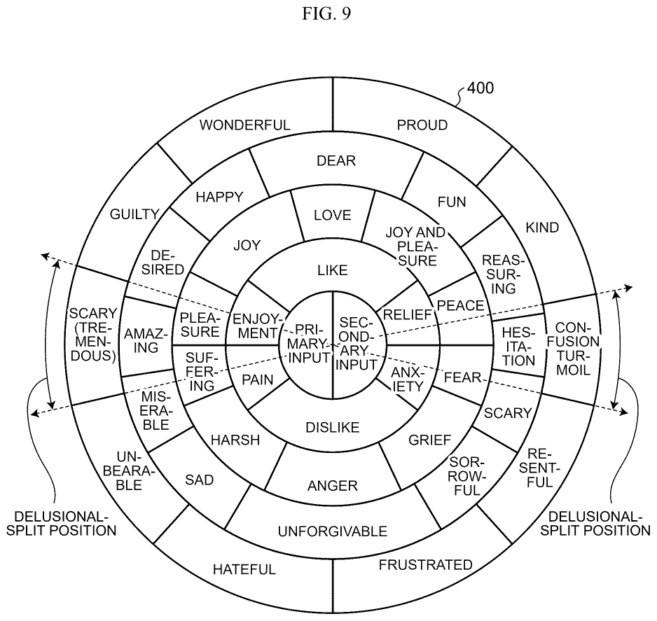

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

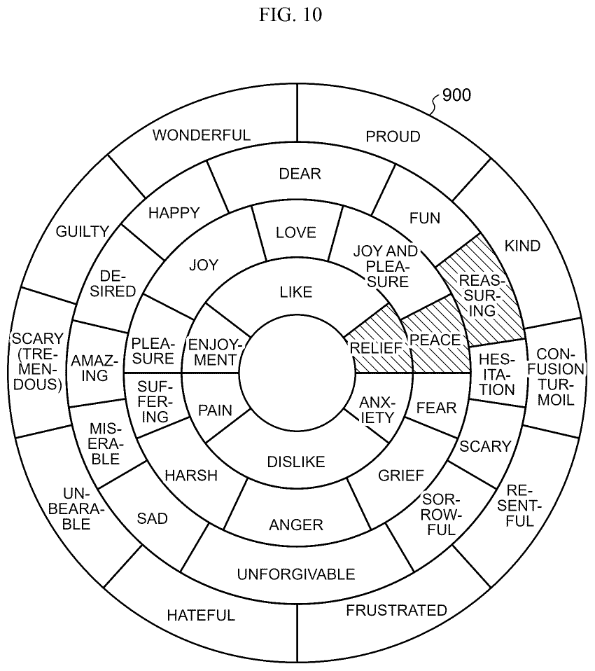

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A logistics center operation support system comprising: a package information management unit; a worker management unit; an equipment management unit; a scheduling optimization unit; a delivery route optimization unit; an education plan proposal unit; a customer response proposal unit; and a trouble sign detection unit, wherein the package information management unit is configured to centrally accumulate and manage package information such as a package ID, a package type, a weight, a size, a storage temperature condition, a scheduled warehousing date, a scheduled delivery date, a delivery destination, and a priority; the worker management unit is configured to manage worker information such as a worker ID, a name, a qualification, an assignable work type, a past work history, a mistake history, a skill evaluation, and a work shift; the equipment management unit is configured to manage equipment information such as an equipment ID, an equipment type, an installation location, an operating time, a maintenance history, sensor data such as temperature and humidity, and a failure history; the scheduling optimization unit is configured to automatically determine an optimal timing and work assignment for warehousing and delivery work using a generative AI based on the priority of the package, a delivery schedule, an availability of equipment, external traffic information, weather information, and the like; the delivery route optimization unit is configured to automatically propose a shortest and safe delivery route using a generative AI based on the delivery destination, a loading status of a delivery vehicle, traffic information, a past delay history, weather information, and the like; the education plan proposal unit is configured to analyze a skill evaluation for each worker, a past mistake history, a customer feedback content, a change in work content, and the like, and automatically generate an individually optimized education and training plan using a generative AI; the customer response proposal unit is configured to analyze the content of the customer feedback using a generative AI, and propose a specific countermeasure such as automatic generation of an apology letter, a compensation proposal, and an explanation of a recurrence prevention measure when there is a low evaluation or a complaint; and the trouble sign detection unit is configured to collate real-time data such as temperature and vibration of equipment, an abnormal flow line of a worker, a past trouble pattern, and the like using a generative AI, and immediately issue an alert when an abnormal sign is detected.

### (Supplementary Note 2)

The logistics center operation support system according to Supplementary Note 1, wherein the scheduling optimization unit is configured to comprehensively analyze the package information, the worker information, and the equipment information accumulated in the package information management unit, the worker management unit, and the equipment management unit, and the traffic information and the weather information acquired from an outside using a generative AI, automatically determine an optimal worker assignment, work timing, and equipment utilization plan for each package in consideration of a type and priority of the package, a skill and qualification of the worker, an operating status and availability of the equipment, a traffic jam, a weather risk, and the like, and simultaneously realize maximization of work efficiency and risk reduction.

### (Supplementary Note 3)

The logistics center operation support system according to Supplementary Note 1, wherein the trouble sign detection unit is configured to analyze real-time equipment sensor data and worker flow line data acquired from the equipment management unit and the worker management unit, and a trouble history and a past accident pattern using a generative AI, and immediately issue an alert notification to an administrator terminal and automatically generate and present a necessary countermeasure and a warning when detecting an abnormal temperature rise or abnormal vibration of the equipment, a flow line pattern of the worker different from normal, a situation similar to a time of a past trouble occurrence, or the like.

What is claimed is:

1. A system comprising:
circuitry configured to:
receive, via a communication interface coupled to a packet-switched network, high-frequency stream data from IoT sensor devices and terminal devices at a site, and structured data records from external data service endpoints, and store the received data in a storage device;
execute primary filtering and compression of the high-frequency stream data at an edge computing node, and transfer compressed data to a cloud computing node via the communication interface, the cloud computing node processing the compressed data using a parallel computing cluster;
apply a generative neural network model to the compressed data and the structured data records to generate a scheduling optimization data record comprising task assignment sequences and resource allocation parameters, and generate a route optimization data record comprising movement path sequences for automated equipment in the site;
apply an anomaly prediction model to time-series sensor data arrays from the IoT sensor devices to detect trouble sign indicators, and generate a maintenance alert data record when a predicted anomaly score exceeds an anomaly threshold parameter; and
transmit the scheduling optimization data record, the route optimization data record, and the maintenance alert data record to terminal devices via the communication interface.

2. The system according to claim 1, wherein the circuitry is configured to receive position coordinate data at a predetermined sampling rate from location sensor devices mounted on automated equipment, construct trajectory data arrays from the position coordinate data, and apply a path deviation detection algorithm to the trajectory data arrays to identify deviations from expected movement patterns.

3. The system according to claim 2, wherein the circuitry is configured to apply a reinforcement learning model to the trajectory data arrays and current scheduling optimization data to compute an updated route optimization data record minimizing a total path cost metric, and transmit route change commands to automated equipment control interfaces via the communication interface.

4. The system according to claim 1, wherein the circuitry is configured to receive numerical parameter data from external data service endpoints comprising environmental condition values and traffic condition indices via the communication interface, normalize the received numerical parameter data, and incorporate the normalized numerical parameter data as additional input features in the generative neural network model during scheduling optimization data record generation.

5. The system according to claim 1, wherein the circuitry is configured to apply a one-dimensional convolutional neural network to time-series sensor data arrays to extract feature vectors, apply a long short-term memory network to the extracted feature vectors to generate multi-step ahead prediction values, and compute the predicted anomaly score by comparing prediction values against observed sensor values using a reconstruction error metric.

6. The system according to claim 5, wherein the circuitry is configured to classify detected trouble sign indicators by anomaly type using a multi-class classification model, generate the maintenance alert data record comprising the anomaly type identifier, the affected equipment identifier, and a recommended inspection action sequence, and transmit the maintenance alert data record to terminal devices associated with maintenance personnel identifiers.

7. The system according to claim 1, wherein the circuitry is configured to apply the generative neural network model to activity records of personnel at the site comprising work history data and performance metric data to generate an education plan data record comprising recommended skill development sequences personalized to each personnel identifier.

8. The system according to claim 7, wherein the circuitry is configured to retrieve reference training content records from a vector database by cosine similarity search using an embedding vector derived from performance metric data associated with a personnel identifier, and incorporate retrieved reference training content records into a retrieval-augmented generation prompt for education plan data record generation.

9. The system according to claim 1, wherein the circuitry is configured to apply a natural language processing model to communication text data received from terminal devices to extract request classification labels and urgency indicators, and generate a response proposal data record by applying the generative neural network model to the request classification labels, historical interaction records, and preference profile records retrieved from the storage device.

10. The system according to claim 9, wherein the circuitry is configured to update preference profile records in the storage device by extracting preference patterns from historical request classification labels and corresponding validated response proposal records, and regenerate response proposal data records using updated preference profile records for subsequent requests from the same user identifier.

11. The system according to claim 1, wherein the circuitry is configured to generate a synchronization control signal set by applying the generative neural network model to the scheduling optimization data record and current status data from all automated equipment at the site, and transmit the synchronization control signal set to automated equipment control interfaces to coordinate concurrent operations.

12. The system according to claim 1, wherein the circuitry is configured to aggregate scheduling optimization data records, route optimization data records, and maintenance alert data records into an integrated dashboard data set, and transmit the integrated dashboard data set to terminal devices via the communication interface as a JSON data structure formatted for display in a unified operational view.

13. The system according to claim 12, wherein the circuitry is configured to update the integrated dashboard data set at a configurable refresh interval by re-applying the generative neural network model to the most recent compressed data and structured data records, and transmit push notification data to terminal devices when a key performance metric in the scheduling optimization data record crosses a configurable alert threshold.

14. The system according to claim 1, wherein the circuitry is configured to distribute incoming high-frequency stream data to a plurality of parallel computing nodes via a load balancer, assign processing priority to data streams having urgency indicator values above a priority threshold, and aggregate processing results from all parallel computing nodes into a unified output for transmission to terminal devices.

15. The system according to claim 1, wherein the circuitry is configured to update the generative neural network model by generating training pairs from historical scheduling optimization data records and corresponding validated throughput outcome records, and fine-tune the generative neural network model on the training pairs to reduce scheduling optimization error on the most recent operational window.

16. The system according to claim 1, wherein the circuitry is configured to encrypt data transmissions between edge computing nodes and cloud computing nodes using a transport layer security protocol, and authenticate edge computing nodes using digital certificates prior to accepting high-frequency stream data for processing.

17. The system according to claim 1, wherein the high-frequency stream data comprises position coordinate data from automated equipment at a logistics processing facility, the structured data records comprise external environmental condition data, and the scheduling optimization data record and route optimization data record correspond to operational scheduling and movement path parameters for the logistics processing facility.

18. A system comprising:
circuitry configured to:
receive, via a communication interface coupled to a packet-switched network, high-frequency stream data from IoT sensor devices and structured data from external data services, and execute primary filtering at an edge computing node prior to transfer to a cloud computing node;
apply a generative neural network model on a parallel computing cluster to compressed stream data and structured data to generate scheduling optimization and route optimization data records;
apply a one-dimensional convolutional neural network and a long short-term memory network to time-series sensor data arrays to generate predicted anomaly scores, and generate maintenance alert data records when predicted anomaly scores exceed anomaly threshold parameters;
apply a natural language processing model to communication text data to extract request classification labels, and generate response proposal data records by retrieval-augmented generation conditioned on preference profile records; and
transmit scheduling optimization data records, route optimization data records, maintenance alert data records, and response proposal data records to terminal devices via the communication interface.

19. The system according to claim 18, wherein the circuitry is configured to aggregate scheduling optimization data records, route optimization data records, and maintenance alert data records into an integrated dashboard data set for transmission as a JSON data structure, update the integrated dashboard data set at a configurable refresh interval, and transmit push notification data to terminal devices when key performance metrics cross configurable alert thresholds.

20. A method comprising:
receiving, via a communication interface coupled to a packet-switched network, high-frequency stream data from IoT sensor devices and terminal devices at a site, and structured data records from external data service endpoints, and storing the received data in a storage device;
executing primary filtering and compression of the high-frequency stream data at an edge computing node, and transferring compressed data to a cloud computing node for processing using a parallel computing cluster;
applying a generative neural network model to the compressed data and structured data records to generate a scheduling optimization data record and a route optimization data record;
applying an anomaly prediction model to time-series sensor data arrays to detect trouble sign indicators, and generating a maintenance alert data record when a predicted anomaly score exceeds an anomaly threshold parameter; and
transmitting the scheduling optimization data record, the route optimization data record, and the maintenance alert data record to terminal devices via the communication interface.
